(19) United States
(12) Patent Application Publication
(10) Pub. No.: US 2019/0075097 A1
(43) Pub. Date: Mar. 7, 2019

(54) VERIFICATION SYSTEM

(71) Applicant: KOLUMBO HOLDINGS LIMITED, HONG KONG (HK)

(72) Inventor: Aaron Raymond Campbell, Manly (AU)

(73) Assignee: KOLUMBO HOLDINGS LIMITED, HONG KONG (HK)

(21) Appl. No.: 15/866,556

(22) Filed: Jan. 10, 2018

Related U.S. Application Data
(63) Continuation-in-part of application No. 15/695,041, filed on Sep. 5, 2017.

(51) Int. Cl. H04L 29/06; H04L 29/08; H04W 4/02

(52) U.S. Cl. CPC H04L 63/083; H04L 63/12; H04W 4/02; H04L 67/32; H04L 67/02

(57) ABSTRACT

A method includes receiving an electronic identifier. The electronic identifier includes compressed electronic information. The method further includes analyzing, by an electronic device, the electronic identifier. The method further includes verifying, by the electronic device, the identity of an individual associated with the electronic identifier. The method further includes verifying includes electronically analyzing the compressed information with stored electronic information. The method further includes sending one or more communications that include permission to post services associated with the individual.

### BACKGROUND

There are numerous websites, smartphone applications, other electronic user interfaces, and non-electronic forums (e.g., newspapers, magazines) that contain information about offering one or more different types of services. However, there is currently no system or process that verifies that one or persons, providing the service, are not under duress to conduct the service.

### BRIEF DESCRIPTION OF DRAWINGS

FIGS. 1A-1E is are diagrams of an example environment in which systems and/or methods described herein may be implemented;

FIG. 2 is a diagram of a network environment;

FIG. 3 is a diagram of an example computing device;

FIGS. 4A and 4B are flow diagrams of example communications to initiate a verification process;

FIG. 5 is a flow chart of an example process for verifying information associated with a post;

FIG. 6 is flow chart of an example process for analyzing different types of information;

FIG. 7 is an example database structure that stores electronic information about one or more factors associated with different types of information;

FIGS. 8A and 8B are example database structures that store electronic information for verification;

FIG. 9 is a flow diagram of an example communication associated with additional verifications.

FIG. 10 is an example diagram for analyzing information;

FIG. 11 is an example diagram for analyzing information;

FIG. 12 is an example electronic form;

FIG. 13 is an example electronic post;

FIG. 14 is an example diagram of verifying information based on an electronic post created on a third-party electronic application;

FIGS. 15A and 15B are example diagrams of verifying information in video-based content from a third-party electronic application; and

FIGS. 16A and 16B are example diagrams of verifying information based on electronically generated lists.

### DETAILED DESCRIPTION OF PREFFERED EMBODIMENTS

The following detailed description refers to the accompanying drawings. The same reference numbers in different drawings may identify the same or similar elements.

Systems, devices, and/or methods described herein may allow for a user (or an entity), using an electronic application implemented on a computing device (e.g., smartphone, laptop, etc.) to verify that one or more persons, associated with an electronic post, are not being forced to conduct one or more activities/services described in the electronic (or non-electronic) post against their own free will. For example, a user, using a user device (e.g., computer, laptop, smartphone, etc.) may view a webpage, messaging board, electronic posting board, non-electronic posting board, or newspaper that has one or more posts (electronic or non-electronic) about one or more services. The one or more posts may have information about a type of service that may be conducted in-person or via one or more electronic communications (e.g., video streaming, messages, voice over Internet Protocol (VoIP), etc.).

In embodiments, the systems, devices, and/or methods described herein, verify the identity of the one or more persons, associated with the post; and, that the one or more persons, associated with the service and/or post, are conducting the services and are not being forced by the one or more persons to conduct the services against their free will. In embodiments, conducting an activity or service against one's own free will may equate to a situation when a person is being threatened with physical violence, psychological violence, financial blackmail, and/or physical violence, psychological violence, and/or financial blackmail against someone who is a relative or friend of the person. Thus, a person is under duress from someone (or an entity) that is performing a criminal act to force that person to conduct a certain activity or service.

In embodiments, the verification process includes electronically (and/or non-electronically) verifying the identify (e.g., a person's name, gender, age, nationality, etc.) of one or more persons associated with a post and electronically determining that the one or more persons are conducting the services. In embodiments, the verification process includes one or more processes that analyze one or more factors associated with one or more documents associated with the one or more persons. In embodiments, the documents can be analyzed to determine individuals who would have a likelihood of not being under coercion (i.e., doing something against their free will). In embodiments, the greater number of documents and/or identification information associated with a person, the greater likelihood that the person is not under coercion (e.g., is not a human trafficking victim, slave, indentured servant, etc.). Alternatively, the fewer amount of information and types of information, or without any information, the greater the likelihood that the person is under coercion. In embodiments, after the one or more persons are verified as conducting the services of their own free will, the verification process may include a continuous and/or real-time monitoring and verification process that determines that the one or more verified persons are still conducting the services of their own free will.

By becoming verified by the one or more processes described in the following figures, one or more persons may be verified as not conducting one or more services against their own free will. Thus, the one or more persons may be verified as not being human trafficking victims. Furthermore, the webpages, electronic social networks, newspapers, messaging applications, electronic boards, and/or non-electronic boards may show compliance with one or more regulations regarding the prevention of human trafficking.

Accordingly, the electronic application may provide one or more electronic processes that (1) obtain information about one or more persons, (2) electronically verify information about the one or more persons, (3) electronically determine, using electronic and computing analysis, that the one or more persons are not conducting services against their own free will, and (4) conduct additional verifications on a continuous and/or real-time basis to ensure that the person has not, in the future, become an individual who is being forced to provide services against their own free will (e.g., a human trafficking victim).

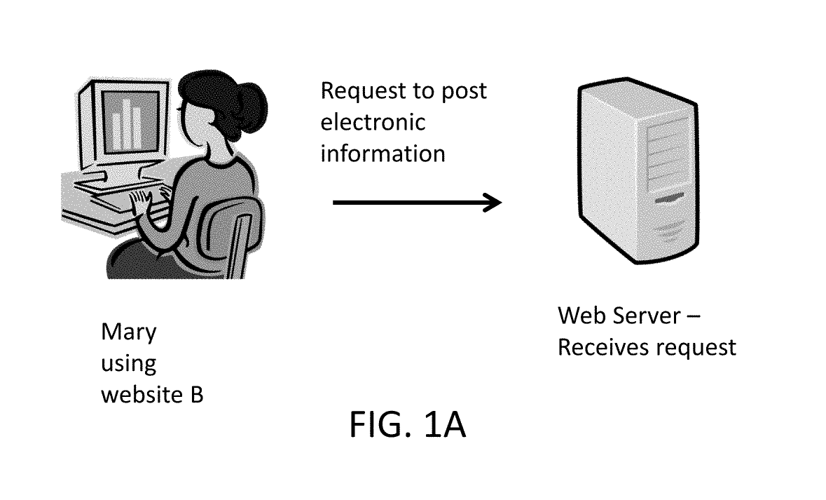

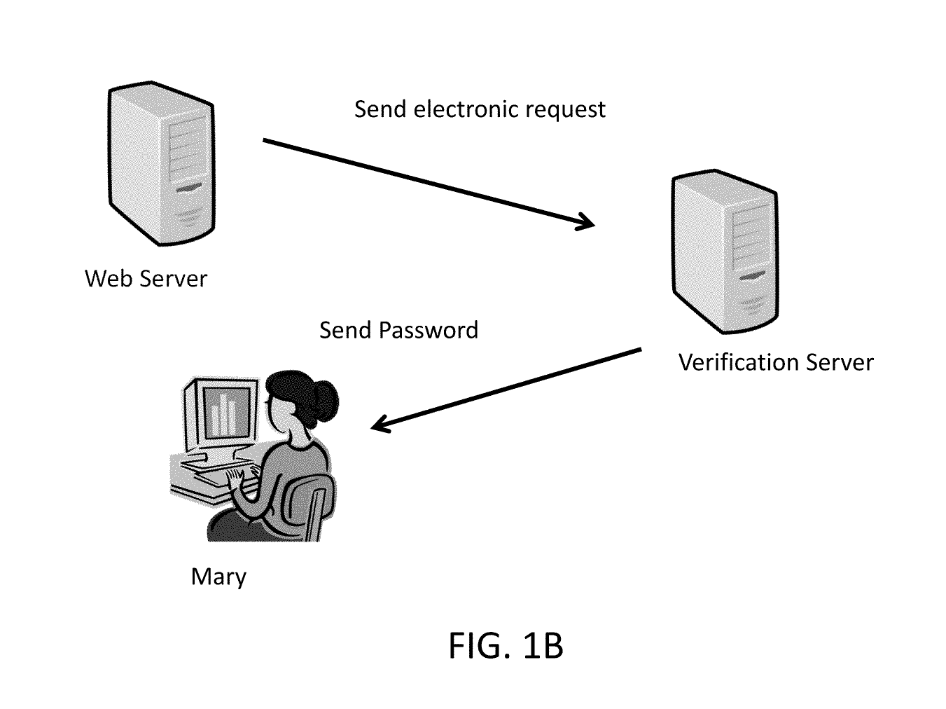

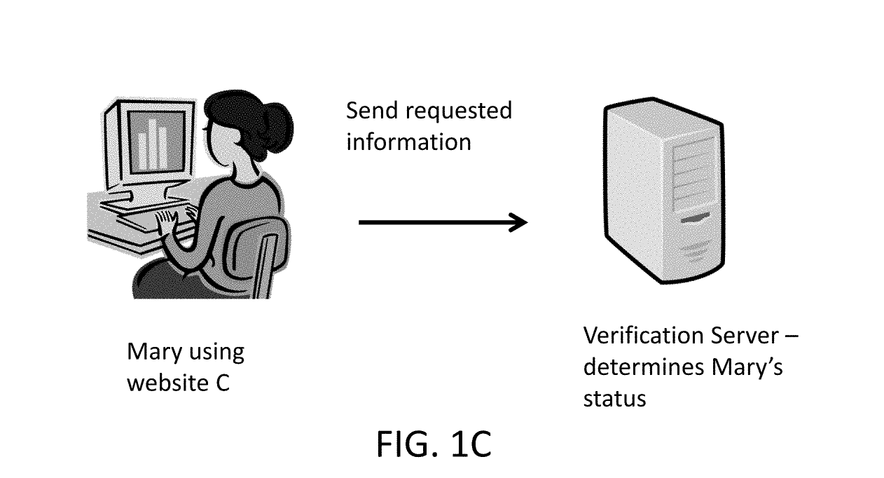

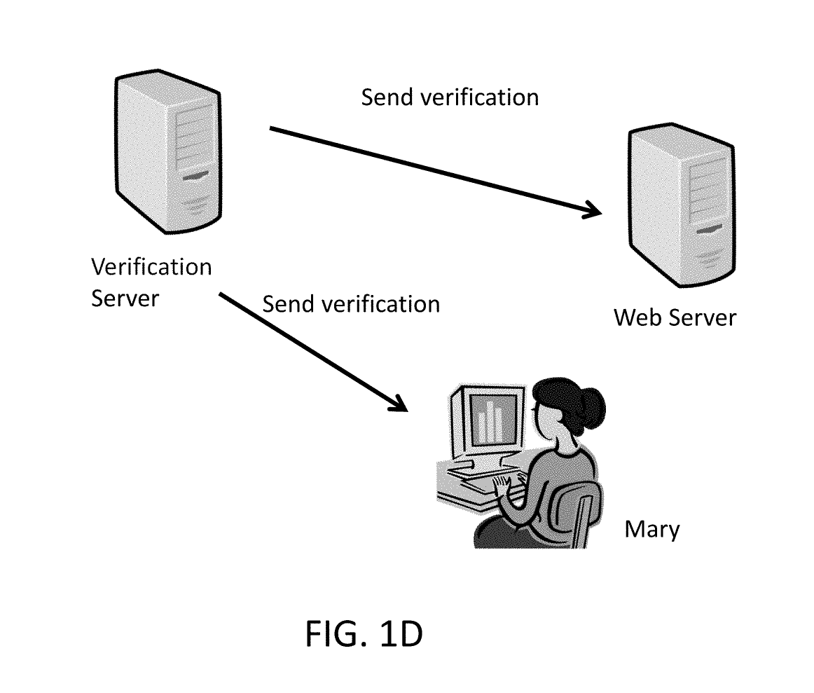

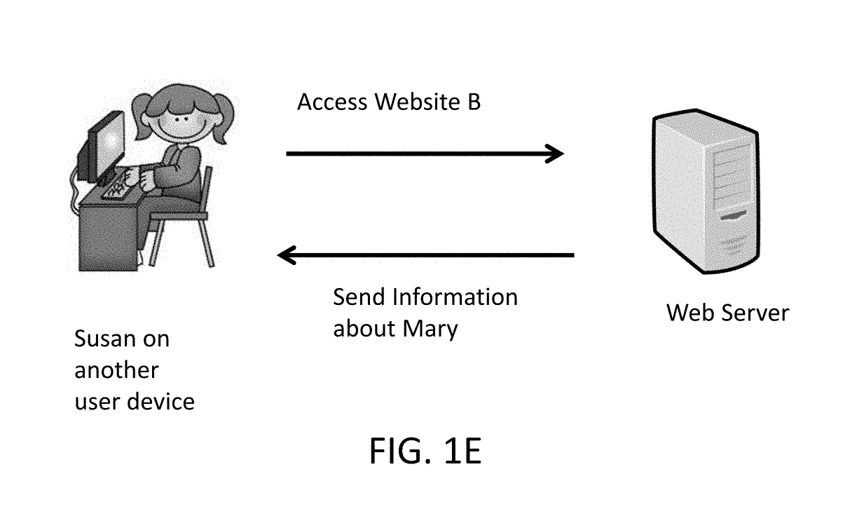

FIGS. 1A-1E describe an example process of verifying that one or more persons is not being forced against their free will to conduct one or more services described in a post. In this non-limiting example, the verification is performed prior to electronically displaying the post on a particular website. As shown in FIG. 1A, a user, Mary, is interested in creating an electronic post on website B by using a user device. As shown in FIG. 1A, using the user device, Mary may send a request (via website B) to post electronic information. The request may be received by a web server associated with website B. As shown in FIG. 1B, the web server may send an electronic request to a verification server regarding Mary's request to create an electronic post on website B. Upon receiving the electronic request, the verification server may send an electronic communication that includes a password to Mary's user device. In this non-limiting example, Mary may receive a text message, email message, etc., which may include a password and an electronic link to website C. In other examples, the password may be a one-time generated password. In other non-limiting examples, the password may be sent to the web server and the web server may then send the password to Mary's user device.

In this non-limiting example, website C (associated with the verification server which may be associated with a third-party independent of the party associated with the web server) may have one or more electronic pages to obtain information from someone (such as Mary) who is looking to create an electronic post on website B. Mary may then use the password in website C, associated with the verification server, to access various electronic pages and enter requested electronic information.

As shown in FIG. 1C, Mary may use website C to enter and send (using the user device) the electronic information to the verification server. As shown in FIG. 1C, the verification server may analyze the received electronic information and verify Mary's identity and/or whether Mary is providing services that she will be conducting of her own free will (e.g., that Mary is not a human trafficking victim). In this non-limiting example, the verification server is able to verify Mary's identity and also determines that Mary's status is not one of being forced to conduct one or more services against Mary's free will. Upon verifying Mary's identity, as shown in FIG. 1D, the verification server may send an electronic verification message to Mary's user device and the web server. Thus, Mary is electronically alerted that she is verified and that she may electronically post on website B. The web server is also electronically alerted by the verification server that Mary is verified in her identity and status (e.g. not being a human trafficking victim) and that she may electronically post on website B.

At a later point and as shown in FIG. 1E, once Mary has been verified and her electronic post has been created is electronically displayed on website B, Susan (another person) may use another user device to access website B and the web server may send electronic information about Mary's post for display on website B.

Thus, as shown in FIGS. 1A-1E, a person who wishes to electronically post services, any user-generated content, and/or non-user generated content on a website may undergo a verification process that verifies the user's identity and/or the user's status as to whether the user is performing the one or more services against the user's free will. In embodiments, the verification of the person and/or the person's status will be based on particular probability level (e.g., 60%, 70%, etc.) or other type of threshold requirement. In embodiments, the threshold requirement for the verification of the identity may be the same or different than the threshold requirement for verifying that a person is not someone being forced to conduct a service against their free will (e.g., not a human trafficking victim).

While FIGS. 1A-1E describe various communications and information in the electronic and technological realm, one or more of the processes may occur in an non-electronic process and/or one or more of the processes may occur using electro-mechanical and/or mechanical devices (e.g., printing presses).

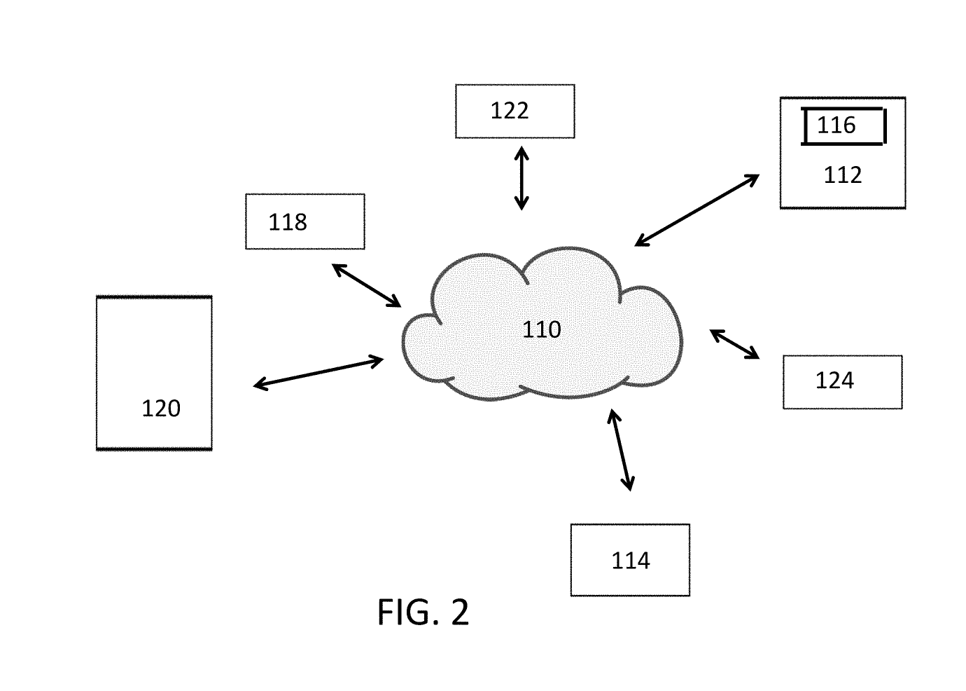

FIG. 2 is a diagram of example environment 100 in which systems, devices, and/or methods described herein may be implemented. FIG. 1 shows network 110, user device 112, user device 114, electronic application 116, web server 118, and verification server 120.

Network 110 may include a local area network (LAN), wide area network (WAN), a metropolitan network (MAN), a telephone network (e.g., the Public Switched Telephone Network (PSTN)), a Wireless Local Area Networking (WLAN), a WiFi, a hotspot, a Light fidelity (LiFi), a Worldwide Interoperability for Microware Access (WiMax), an ad hoc network, an intranet, the Internet, a satellite network, a GPS network, a fiber optic-based network, and/or combination of these or other types of networks. Additionally, or alternatively, network 110 may include a cellular network, a public land mobile network (PLMN), a second generation (2G) network, a third generation (3G) network, a fourth generation (4G) network, a fifth generation (5G) network, and/or another network. In embodiments, network 110 may allow for devices describe any of the described figures to electronically communicate (e.g., using emails, electronic signals, URL links, web links, electronic bits, fiber optic signals, wireless signals, wired signals, etc.) with each other so as to send and receive various types of electronic communications.

User device 112 and/or 114 may include any computation or communications device that is capable of communicating with a network (e.g., network 110). For example, user device 112 and/or user device 114 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a desktop computer, a laptop computer, a tablet computer, a camera, a personal gaming system, a television, a set top box, a digital video recorder (DVR), a digital audio recorder (DUR), a digital watch, a digital glass, or another type of computation or communications device.

User device 112 and/or 114 may receive and/or display content. The content may include objects, data, images, audio, video, text, files, and/or links to files accessible via one or more networks. Content may include a media stream, which may refer to a stream of content that includes video content (e.g., a video stream), audio content (e.g., an audio stream), and/or textual content (e.g., a textual stream). In embodiments, an electronic application may use an electronic graphical user interface to display content and/or information via user device 112 and/or 114. User device 112 and/or 114 may have a touch screen and/or a keyboard that allows a user to electronically interact with an electronic application. In embodiments, a user may swipe, press, or touch user device 112 and/or 114 in such a manner that one or more electronic actions will be initiated by user device 112 and/or 114 via an electronic application.

User device 112 and/or 114 may include a variety of applications, such as, for example, a verification application, an e-mail application, a telephone application, a camera application, a video application, a multi-media application, a music player application, a visual voice mail application, a contacts application, a data organizer application, a calendar application, an instant messaging application, a texting application, a web browsing application, a blogging application, and/or other types of applications (e.g., a word processing application, a spreadsheet application, etc.).

Electronic application 116 may be capable of interacting with user device 112, user device 114, web server 118, and/or authentication server 120 to automatically and electronically analyze electronic information and determine whether to electronically verify information associated with one or more persons. In embodiments, electronic application 116 may obtain electronic information about a person's identity, such as name, address, age, citizenship, financial information, driver's license information, mortgage/rental information, and/or any other type of information associated with identifying a person. In embodiments, electronic application 116 may interact with application programming interfaces (APIs) to obtain electronic information from other electronic applications. In embodiments, electronic application 116 may be electronically configured to show photos, video, text, icons, graphical images, buttons, emojis, and/or any other electronic information. While FIG. 2 shows electronic application 116 on user device 112, electronic application 116 can also be stored on user device 114, and/or verification server 120.

Web server 118 may include one or computational or communication devices that gather, process, store, and/or provide information relating to one or more web pages or electronic pages that electronically display posts (e.g., advertisements, posts, messages) associated with the one or more services.

Verification server 120 may include one or more computational or communication devices that gather, process, store, and/or provide information relating to one or more web pages or electronic pages associated with electronic application 116 that is searchable and viewable over network 110. While FIG. 2 shows a verification server 120 there may be additional verification servers 120 associated with one or more electronic applications 116. In embodiments, verification server 120 may verify a person's identity and/or verify whether the person is conducting one or more services of the person's own free will. In embodiments, verification server 120 may have one or more APIs to perform electronic analysis and/or verification process and one or more database structures to store information about different types of documents, images, electronic communications, and/or other types of information. In embodiments, verification server 120 may be electronically controlled by an entity that is different (and/or independent) of another entity that controls web server 118; or, verification server 120 may be electronically controlled by the same entity that controls web server 118. In embodiments, one, some, or all of the verification and/monitoring processes of verification server 120 may be performed by web server 118.

While FIG. 2 shows electronic application 116, there may be multiple different types of electronic applications 116 that each has their own server(s) that are similar to verification server 120.

Social network server 122 may include one or more computational or communication devices that gather, process, store, and/or provide information relating to one or more web pages or electronic pages that electronically display posts (e.g., advertisements, posts, messages) that are part of an electronic social networking site that allows one or more individuals to share information with other individuals. Server 124 may include one or more computational or communication devices that gather, process, store, and/or provide information relating to location address information, Internet Protocol (IP) addresses, driver license information, mortgage information, rental information, bank information, taxation information, social security information, utility bill payment information, credit card information, passport information, educational information, and/or any other type of information that may be used to identify one or more persons.

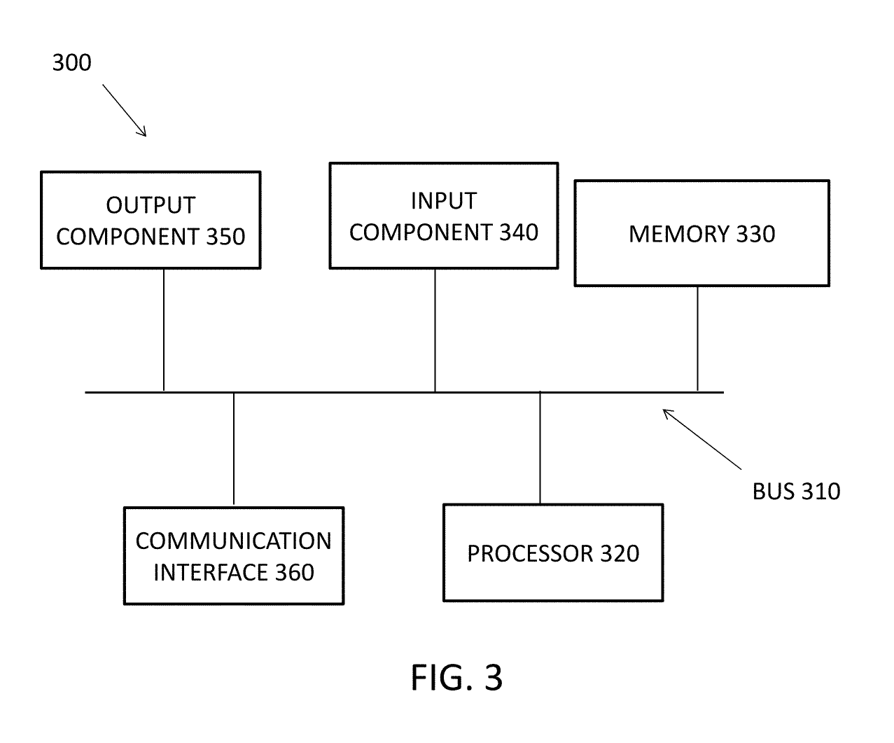

FIG. 3 is a diagram of example components of a device 300. Device 300 may correspond to user device 112, user device 114, web server 118, verification server 120, social network server 122, and server 124. Alternatively, or additionally, user device 112, user device 114, web server 118, verification server 120, social network server 122, and server 124 may include one or more devices 300 and/or one or more components of device 300.

As shown in FIG. 3, device 300 may include a bus 310, a processor 320, a memory 330, an input component 340, an output component 350, and a communications interface 360. In other implementations, device 300 may contain fewer components, additional components, different components, or differently arranged components than depicted in FIG. 3. Additionally, or alternatively, one or more components of device 300 may perform one or more tasks described as being performed by one or more other components of device 300.

Bus 310 may include a path that permits communications among the components of device 300. Processor 320 may include one or more processors, microprocessors, or processing logic (e.g., a field programmable gate array (FPGA) or an application specific integrated circuit (ASIC)) that interprets and executes instructions. Memory 330 may include any type of dynamic storage device that stores information and instructions, for execution by processor 320, and/or any type of non-volatile storage device that stores information for use by processor 320. Input component 340 may include a mechanism that permits a user to input information to device 300, such as a keyboard, a keypad, a button, a switch, voice command, etc. Output component 350 may include a mechanism that outputs information to the user, such as a display, a speaker, one or more light emitting diodes (LEDs), etc.

Communications interface 360 may include any transceiver-like mechanism that enables device 300 to communicate with other devices and/or systems. For example, communications interface 360 may include an Ethernet interface, an optical interface, a coaxial interface, a wireless interface, or the like.

In another implementation, communications interface 360 may include, for example, a transmitter that may convert baseband signals from processor 320 to radio frequency (RF) signals and/or a receiver that may convert RF signals to baseband signals. Alternatively, communications interface 360 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communications interface 360 may connect to an antenna assembly (not shown in FIG. 3) for transmission and/or reception of the RF signals. The antenna assembly may include one or more antennas to transmit and/or receive RF signals over the air. The antenna assembly may, for example, receive RF signals from communications interface 360 and transmit the RF signals over the air, and receive RF signals over the air and provide the RF signals to communications interface 360. In one implementation, for example, communications interface 360 may communicate with network 110.

As will be described in detail below, device 300 may perform certain operations. Device 300 may perform these operations in response to processor 320 executing software instructions (e.g., computer program(s)) contained in a computer-readable medium, such as memory 330, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

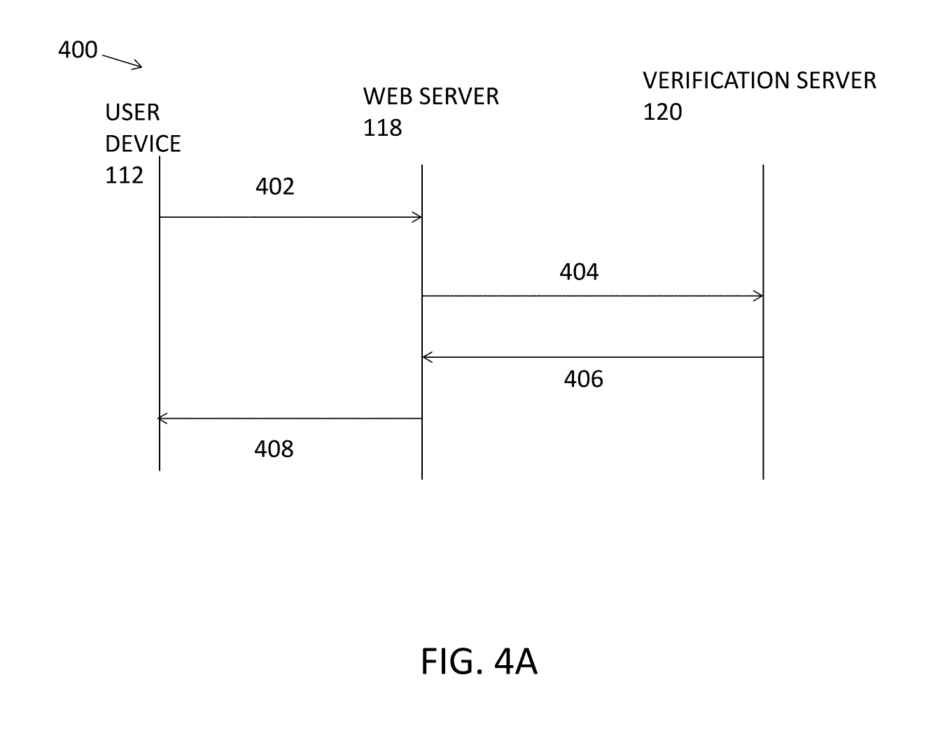

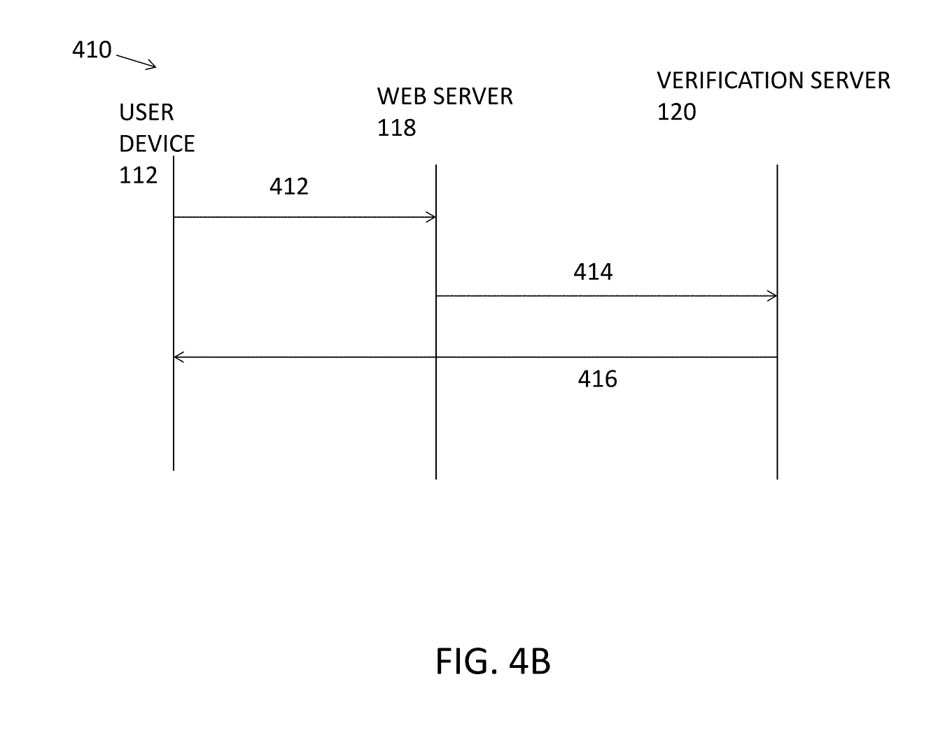

FIG. 4A describes an example communication flow process 400 for generating an electronic password. As shown, FIG. 4A includes user device 112, web server 118, and verification server 120. In embodiments, as shown in FIG. 4A, user device 112 (based on instructions for a user of user device 112) may send an electronic request 402 to post (e.g., a message, advertisement, etc.) an electronic post on a website associated with web server 118. In embodiments, the electronic post may include any type of user-generated content (e.g., text, numbers, images, multimedia content, etc.). In embodiments, web server 118 may send an electronic communication 404 to verification server 120. In embodiments, verification server 120 may, upon receiving the electronic communication, send a password via a second electronic communication 406 to web server 118. In turn, web server 118 may send the password via a third electronic communication 408. In embodiments, the third electronic communication may be sent as a short message service (SMS), a multimedia message service (MMS), an email, a phone call, and/or any other type of electronic message that includes a password, instructions, icons, and/or links (e.g., hyperlinks) that allow the user to interact with a website associated with verification server 120. Accordingly, the user of user device 112 may then use the password in another website associated with verification server 120 to begin the process of entering electronic information.

FIG. 4B describes an example communication flow process 410 for generating an electronic password. As shown, FIG. 4B includes user device 112, web server 118, and verification server 120. In embodiments, as shown in FIG. 4B, user device 112 (based on instructions for a user of user device 112) may send an electronic request 412 to post (e.g., a message, advertisement, etc.) an electronic post on a website associated with web server 118. In embodiments, web server 118 may send an electronic communication 414 to verification server 120. In embodiments, verification server 120 may, upon receiving the electronic communication, send a password via a second electronic communication 416 to user device 112. In embodiments, the second electronic communication may be sent as a short message service (SMS), a multimedia message service (MMS), an email, a phone call, and/or any other type of electronic message that includes a password, instructions, icons, and/or links (e.g., hyperlinks) that allow the user to interact with a website associated with verification server 120. Accordingly, the user of user device 112 may then use the password in another website associated with verification server 120 to begin the process of entering electronic information.

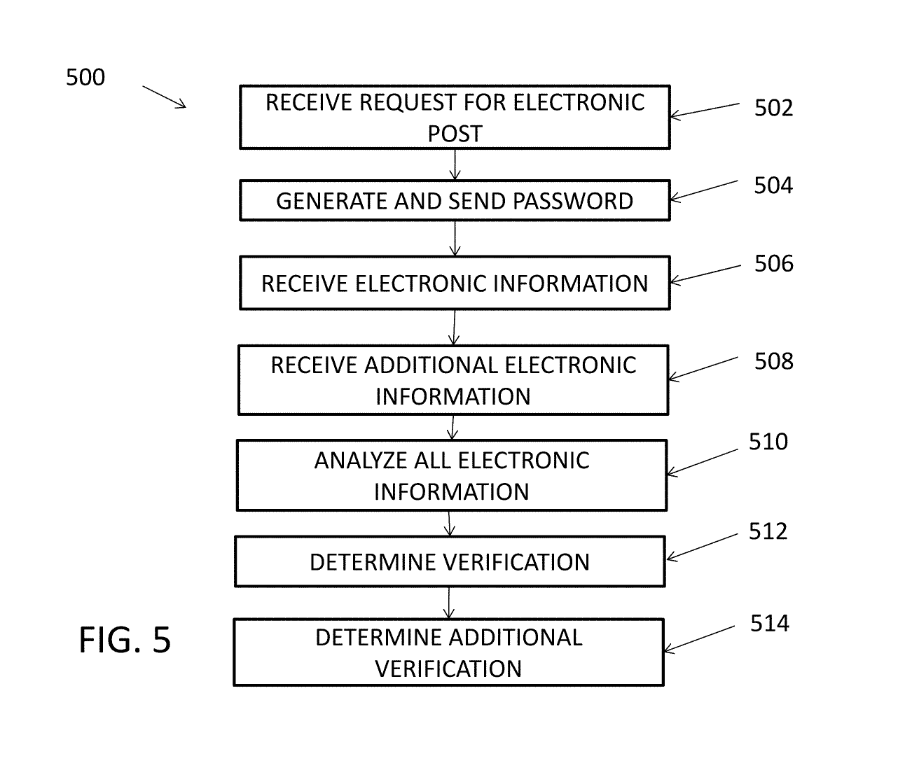

FIG. 5 is a flow chart of an example process 500 for verifying information prior to (and after) electronically displaying an electronic post. In embodiments, example process 500 may be performed by electronic application 116 and/or verification server 120 receiving electronic information from user device 112 and other computing devices, such as web server 118, social network server 122, and/or server 124.

At step 502, electronic application 116 and/or verification server 120 may receive a request for creating an electronic post (e.g., a proposed electronic post to be electronically displayed on a website associated with web server 118). In embodiments, the electronic post may include any user-generated (or non-generated) content that can be electronically displayed on a website, gaming application, messaging application, social networking website or application, and/or any other electronic forum for interacting with other people. In embodiments, the user-generated content may be associated with a multi-media streaming application (e.g., associated with a webcam or other video system to generate the multi-media content), or with text-based content (e.g., associated with SMS or MMS messaging that would allow the user to electronically communicate with other users via SMS or MMS messaging systems). In alternate embodiments, the request for creating the electronic post may be include audio information associated with the user. For example, the audio information may be a sound of the user's voice. In alternate embodiments, the user may provide the voice via a phone or via a microphone that can send electronic information about the voice to electronic application 116 and/or verification server 120. At step 504, electronic application 116 and/or verification server 120 may generate and send a password to a user device (e.g., user device 112). In embodiments, a user of user device 112 may enter the password and may also enter an identifier (e.g., a phone number, a mobile identification code, etc.) into one or more electronic pages (e.g., a website) associated with electronic application 116 that will then allow electronic application 116 and/or verification server 120, at step 506, to receive electronic information. In alternate embodiments, electronic application 116 and/or verification server 120 may use the electronic information associated with the user's voice to confirm the user's identity in addition, or alternatively, to the generated password. In embodiments, based on the information inputted by the user of user device 112, electronic application 116 and/or verification server 120 may also request (based on permissions from the user of user device 112) and receive, at step 508, additional electronic information from other sources, such as social networking server 122 and/or server 124.

At step 510, electronic application 116 and/or verification server 120 may analyze the electronic information received in step 506 and/or the additional electronic information received in step 508. In embodiments, electronic application 116 and/or verification server 120 may analyze the electronic information and/or the additional electronic information to verify the claimed identify of the user (or other person) of user device 112 who may provide services provided in the electronic post. In embodiments, electronic application 116 and/or verification server 120 may analyze the electronic information and/or the additional electronic information to verify that the user of user device 112, or another person identified with providing a service, is not conducting the service against their own free will. In embodiments, electronic application 116 and/or verification server 120 may request criminal background information and/or immigration status information. In embodiments, a person's age (associated with the electronic post) is analyzed with the content in the electronic post to determine that the person is at a particular age to provide the services described in the electronic post. In embodiments, verification server 120 may electronically receive, via one or more APIs, electronic information (simultaneously and/or in real-time) information from governmental electronic databases (e.g., voter registration, licensure information, etc.) and other types of electronic databases (e.g., credit score information). In embodiments, the governmental and the other types of electronic databases may be associated with computing hardware that is associated with other electronic entities that have their computing hardware independently controlled from verification server 120. In embodiments, verification server 120 may receive electronic information about a person's past electronic transactions, such as electronic transactions for particular products and/or services. In embodiments, the received electronic information may be used to analyze a person's digital footprint (e.g., based on electronic and/or non-electronic actions taken by the person).

For example, past electronic transactions may be associated with products and/or services that require a particular age requirement or may require information that indicates that the person is of a particular age (e.g., real estate purchase, automobile purchase, etc.). In embodiments, verification server 120 may receive electronic information about psychological testing that was taken by the user. In embodiments, verification server 120 may receive electronic information associated with electronic posts from other websites, such as social networking websites (e.g., electronic websites associated with electronically connecting and messaging to other users based on common interests), online electronic commerce sites, and/or online information about content viewed (e.g., streaming video content, photos, etc.) by the user. In embodiments, verification server 120 may receive electronic information about time-based activities. For example, verification server 120 may receive time-based electronic information about how often a smart-phone requires charging, the period of time a smart-phone is used, the amount of time associated with responding to an incoming electronic message (e.g., email, text messages, etc.). In embodiments, verification server 120 may receive the time-based electronic information from another server, associated with providing smart-phone or Internet service, or from the user device itself In embodiments, verification server 120 may use the time-based electronic information to electronically determine a person's electronic behavior and digital footprint to determine how a person may electronically communicate and verify one or more characteristics of a person (e.g., age, immigration status, electronic identity, identifier, etc.).

At step 512, electronic application 116 and/or verification server 120 may determine verification of the user of user device 112, or another person identified with providing a service, is not conducting the service (described in the proposed electronic post) against their own free will. In embodiments, electronic application 116 and/or verification server 120 may send an electronic communication to a website, associated with web server 118, that the user of user device 112 and/or other persons have or have not been verified. In embodiments, the age of the user, or another person, may be verified by electronic application 116 and/or verification 120. In embodiments, if the user or another person has been verified, the website may then permit the user of user device 112 and/or other persons to electronically post on the website. In embodiments, the user's identity may be verified but not the user's status (e.g., as not being a human trafficking victim). In the event that a person is not verified, electronic application 114 and/or verification server 120 may send an electronic message to web server 114 indicating that verification did not occur. In embodiments, the electronic message may request the user to provide additional information that can be sent via additional electronic communications. In embodiments, electronic application 116 and/or verification server 120 may determine, based on past electronic transactions by the user of user device 112, that the user is acting without any coercion.

In embodiments, the verification of the person's identity and status (e.g., not a human trafficking victim) may be used to generate a digital certificate that may be used on other websites, applications, and/or electronic communication platforms. In embodiments, the other websites, applications, and/or electronic communication platforms may be associated with multimedia communications (e.g., webcams), text messaging systems (e.g., SMS or MMS messaging) or telephone conversations. Thus, the user may not be required to provide duplicate documents and/or information to regenerate the verification. Thus, the number of electronic communications and computing resources are reduced by creating one digital certificate that can be used on multiple websites and/or applications associated with other computing devices. In embodiments, the digital certificate may also be generated in physical form and may be provided for display to governmental and/or regulatory agencies, and the general public, to confirm that the user is not a human trafficking victim.

In embodiments, electronic application 116 and/or verification server 120 may generate an electronic list of verified users that is then sent to other websites and/or electronic applications. In embodiments, the electronic list may be analyzed with a particular API that allows the other websites and/or electronic applications to store the electronic list. Thus, in embodiments, the other websites and/or electronic applications may analyze more than one user against received requests for electronic posts (e.g., electronic advertisements) to verify one or more persons associated with the requests for electronic posts at one time. Accordingly the other websites and/or electronic applications may determine that requested electronic posts are associated with verified persons without having to send an electronic request for verification. Thus, the other websites and/or electronic applications have pre-verified individuals who, in the future, may decide to post electronic posts on the other websites and/or electronic applications. In embodiments, the electronic communication of the electronic list of verified users may reduce electronic communications needed to determine verification of a person.

In embodiments, the electronic list may include different levels of verifications. For example, a user identified on the electronic list may only be allowed to electronically generate and provide content for one type of service while another user may be restricted in providing any content for the same service. In embodiments, the verification levels may be based on the quantity and time of past electronic communications. For example, a user that has had a particular number of electronic communications within a particular time period may have a greater level of verification than another user that has not conducted a particular number of electronic communications with the particular time period. In embodiments, the other websites and/or electronic applications may determine the different levels of verification. In embodiments, the electronic list may be defined by the type of information electronically posted on the other websites and/or electronic applications. For example, a website that provides service types one and two may only receive an electronic list of users, who are verified, that have previously provided service types one and two. Additionally, or alternatively, a website that provides service types three and four may only receive an electronic list of users, previously verified, that have previously provided service types three and four.

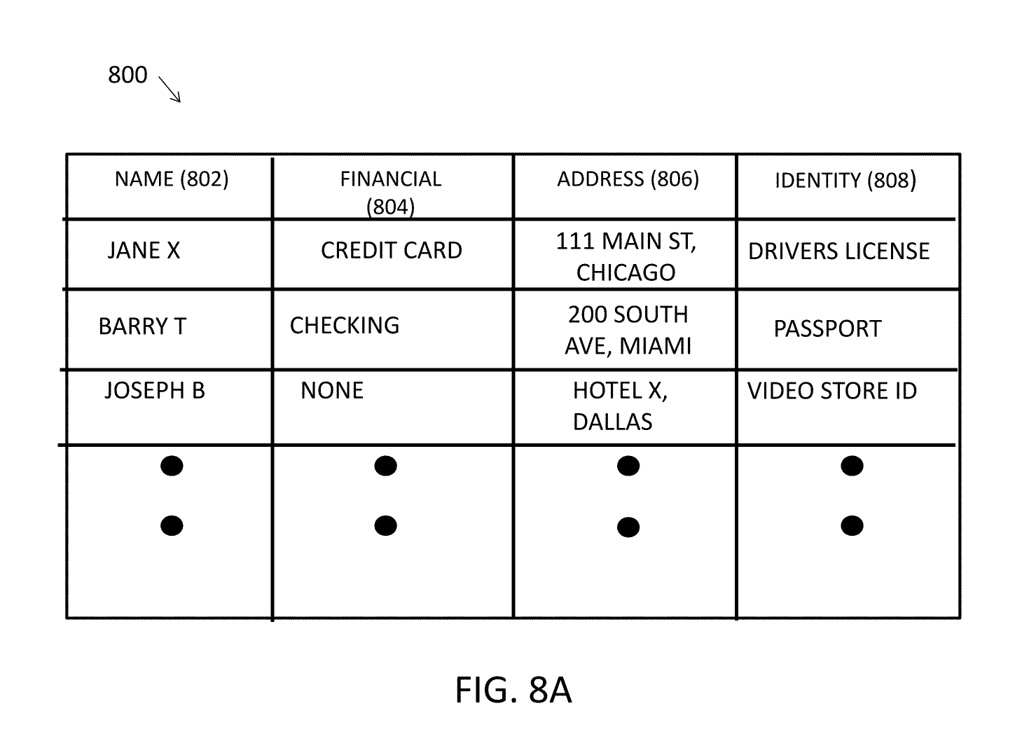

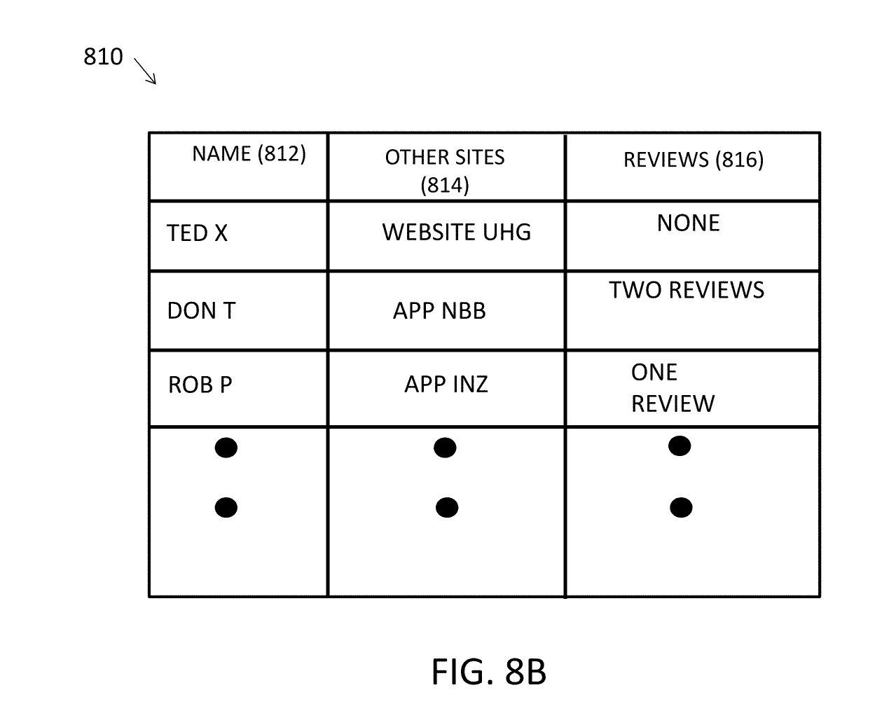

At step 514, electronic application 116 and/or verification server 120 may perform additional verifications after the electronic post is electronically displayed on a website, application, and/or another electronic communications platform. In embodiments, electronic application 116 and/or verification server 120 may automatically receive, or request, electronic communications that include information about other electronic posts, messages, videos, photos, and/or other information electronically crated by the user and/or other users. In embodiments, electronic application 116 and/or verification server 120 may automatically receive, or request, electronic communications from other user (using other user devices, such as user device 114) that include reviews of services provided by the user. In embodiments, electronic application 116 and/or verification server 120 may receive electronic information about electronic services provided by the user, such as live-streaming videos, SMS messages, MMS messages, webcam messaging systems, VoIP, and/or other types of electronic services. In embodiments, electronic application 116 and/or verification server 120 may analyze the electronic information for phrases, images, and/or other information that indicate activities that are appropriate for a person over the age of 18. For example, electronic application 116 and/or verification server 120 may search for inappropriate language (e.g., language that may result in expulsion or suspension from an educational institute or termination from employment) that would indicate services that indicate a person is a human trafficking victim. In embodiments, electronic application 116 and/or verification server 120 may analyze the words to determine other types of individuals who may be coercing a person to be a human trafficking victim and/or a person who is conducting a criminal (e.g., violence, robbery, drugs etc.) activity. In embodiments, electronic application 116 and/or verification server 120 may analyze biometric information in the electronic information (e.g., facial features). In embodiments, the additional verification information (e.g., photos, videos, or text about activities being conducted by the person in the real-world) may be received from a user using a user device (e.g., user device 114) at the same location or in near proximity (e.g., within one mile, two miles, etc.) to the person who has been previously verified and requires monitoring and/or additional verification. In embodiments, electronic application 116 and/or verification server 120 may perform additional verifications based on using one or more databases, such as described in FIGS. 8A and 8B.

In embodiments, if the additional verifications determine that the user cannot be verified as a human trafficking victim, electronic application 116 and/or verification server 120 may send an electronic message to a web server (e.g., web server 118) that the user is not verified and that the electronic post should be electronically removed from the website associated with the web server.

While steps 502, 504, 506, 508, 512, and 514 are described as electronic communications between different computing devices, in alternate embodiments, steps 502, 504, 506, 508, and 512 may be performed in a non-electronic environment. In alternate embodiments, step 502 may be performed by providing information via phone, fax, and/or in person. In alternate embodiments, the electronic post is a non-electronic post that can include user-generated or non-user generated content. In alternate embodiments, step 504 may be a password that is sent via postal mail, phone message, or in person. In alternate embodiments, information in steps 506 and/or 508 may be received via a phone conversation, faxed information, and/or in person. In alternate embodiments, at step 512, electronic application 116 and/or verification server 120 may send a communication (e.g., electronic, paper-generated document, fax, phone call) to an entity (or person) that produces a publication (e.g., a newspaper, advertisement flyer, magazine, etc.) and indicate that a particular person has been verified. In embodiments, one, some, or all of the verification and/monitoring steps in FIG. 5 performed by electronic application 116 and/or verification server 120 may be performed by web server 118.

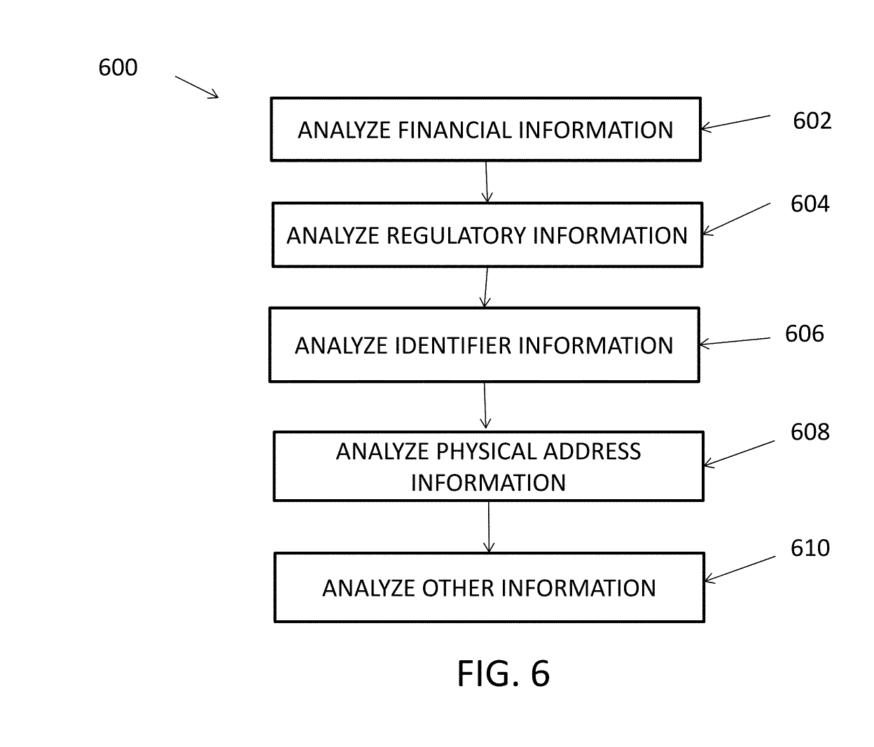

FIG. 6 is a flow chart of an example process 600 for analyzing different types of information. In embodiments, example 600 may be performed by electronic application 116 and/or verification server 120 based on receiving electronic information from user device 112 and other computing devices, such as web server 118, social network server 122, and/or server 124. In embodiments, the one or more steps in FIG. 6 may be associated with step 510 in example FIG. 5.

At step 602, electronic application 116 and/or verification server 120 may analyze financial information. In embodiments, the financial information may be received via one or more electronic communications from other computing devices as described in FIG. 2. In embodiments, the financial information may include mortgage information, personal loan information, credit card information, auto loan documents, salary information, brokerage account information, pension information, mutual fund information, and/or any other type of information that provides loan payments, assets, and/or income information.

At step 604, electronic application 116 and/or verification server 120 may analyze regulatory information. In embodiments, the regulatory information may be received via one or more electronic communications from other computing devices as described in FIG. 2. In embodiments, the regulatory information may include taxation information (e.g., property tax information, personal tax information, business tax information), marriage certificate information, military service information, professional licensure information (law license, medical license, etc.), automobile registration, and/or any other type of certification, taxation, and/or governmental document without a photo identification.

At step 606, electronic application 116 and/or verification server 120 may analyze identifier information. In embodiments, the identifier information may be received via one or more electronic communications from other computing devices as described in FIG. 2. In embodiments, the identifier information may include driver licensure information, commercial driver licensure information, passport information, immigration identification information, student identification, governmental identification, military identification, and/or any other type of photo-based identification. In embodiments, electronic application 116 and/or verification server 120 may analyze the identifier information for gender, age, nationality, and/or any other information.

At step 608, electronic application 116 and/or verification server 120 may analyze physical address information. In embodiments, the physical address information may be received via one or more electronic communications from other computing devices as described in FIG. 2. In embodiments, the physical address information may include street address information, street name information, locality information (e.g., village, town, city, county, borough, state, etc.), and/or country information. In embodiments, the physical address information may be associated with a home address and/or an employment/business address. In embodiments, the physical address information may include duration of time at a particular physical address. For example, the physical address information may include the number of residences associated with a person over a period of time (e.g., the last year, the last two years, the last five years, etc.).

At step 610, electronic application 116 and/or verification server 120 may analyze other types of information. In embodiments, the other types of information may be received via one or more electronic communications from other computing devices as described in FIG. 2. In embodiments, the other types of information may include review information associated with a person associated with providing the service in the proposed electronic post. In embodiments, the review information may include electronic information about fraudulent electronic activity (e.g., illegal electronic transactions) that may be analyzed for the amount and the electronic communications associated with the fraudulent electronic activity. In embodiments, the other types of information may include electronic information received from social networking electronic websites and/or applications, such as electronic posts, photos, videos, and/or any other type of information. In embodiments, electronic application 116 and/or verification server 120 may generate an electronic request for an online electronic interview (or over-the-phone interview) with the person who is associated with providing the service in the proposed electronic post. In embodiments, the online electronic interview may allow for audio, video, and/or other types of multimedia electronic information occurring via electronic application 116 (or within a website associated with web server 118) to be analyzed for video and/or audio information that can be used to verify a person's identity and/or their status as not a human trafficking victim. In embodiments, electronic application 116 and/or verification server 120 may generate a personality test where electronic values associated with each answer on the personality test that are used to determine a person's identity and/or their status as not a human trafficking victim.

In embodiments, electronic application 116 and/or verification server 120 may analyze the service description and/or any other user-generated or non-user generated content described in the proposed electronic post. In embodiments, the proposed electronic post may include one or more services and other user-generated content that may be analyzed. In embodiments, particular words, numbers, images, videos, and/or other information may be analyzed in the proposed electronic post and compared with the information provided in steps 602 to 610. For example, electronic application 116 and/or verification server 120 may determine that the service described in the proposed electronic post is not allowed based on the person's identity (e.g., the person's age or nationality). In embodiments, one, some, or all of the analysis steps in FIG. 6 performed by electronic application 116 and/or verification server 120 may be performed by web server 118.

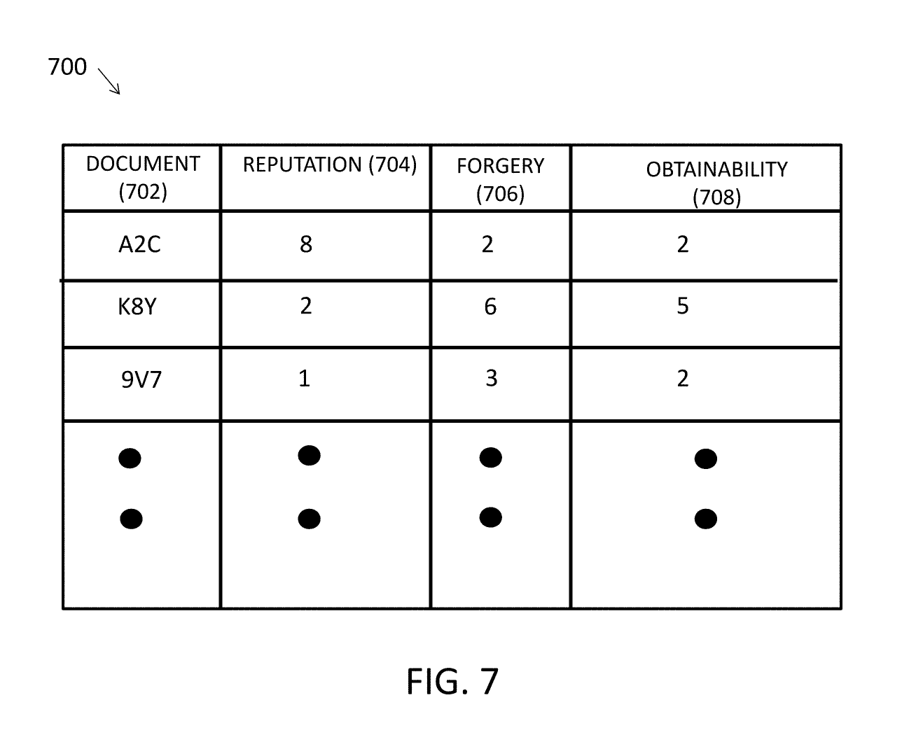

FIG. 7 describes an example data structure 700 that stores one or more factors that are used to verify a person's identity and/or to verify that a person is not being forced to conduct services against their free will (e.g., not a human trafficking victim). In embodiments, data structure 700 may include a collection of fields such as Document 702, Reputation 704, Forgery 706, and Obtainability 708. Although FIG. 7 shows example fields 702-708, in other embodiments, data structure 700 may include fewer fields, different fields, additional fields, and/or differently arranged fields than depicted in FIG. 7. In embodiments, verification server 120 may store some or all of data structure 700. Additionally, or alternatively, user device 112 and/or web server 118 may store some or all of data structure 700.

In embodiments, Document 702 may store identifier information about a particular document obtained for a person who would like to post services. In embodiments, a document identified in field Document 702 may be obtained by a process similar to that described in FIG. 5. For example, in a non-limiting way, “K8Y” may be for a drivers license. In embodiments, for a particular document, described in Document 702, a reputation, forgery, and obtainability value is determined and stored in Reputation 704, Forgery 706, and Obtainability 708 fields, respectively. In embodiments, Reputation 704 may store a value associated with a level of reputation with one or more types of information (e.g., a document or information in Document 702) received by electronic application 116 and/or verification server 120. In embodiments, the value may be determined based on analyzing the one or more types of information described in the one or more steps in FIG. 6. For example, as shown in FIG. 7, document 9V7 has a level of reputation of 1. In embodiments, different types of information may have different reputation values. For example, a passport from one country may have a greater value generated for reputation than a passport from another country. In embodiments, the more reputable the document, the higher the value. In alternate embodiments, the more reputable the document, the lower the value. In embodiments, the gross domestic product of a country providing the document, the strength of a currency associated with the country providing the information, the credit rating associated with the governmental or financial organization that generated the information (e.g., a credit line from a bank with a AAA bond rating may have a greater level of reputation than a bank that has a BBB bond rating), a corruption index rating associated with the country providing the document, and/or any other information associated with determining the level of reputation.

In embodiments, Forgery 706 may store a value associated a level of forgery with one or more types of information (e.g., a document or information in Document 702) received by electronic application 116 and/or verification server 120. In embodiments, the value may be determined based on analyzing the one or more types of information described in the one or more steps in FIG. 6. For example, as shown in FIG. 7, document A2C has a level of forgery value of 2. In embodiments, different types of information may have different values associated with forgery ability. For example, a university identification card is most likely more easily to forge than a driver's license. In embodiments, the easier it is to forge a document, the lower the value. In alternate embodiments, the easier it is to forge a document, the higher the value. In embodiments, the value associated with forgery may be associated with an analysis of the type of agency that provides the documents, the number of secure access channels associated with the type of agency, the level of expense associated with creating a forgery, a determined value of the number of documents currently available, a determined value of the number of documents that can be stolen and used for forgery, any electronic or cryptology feature associated with the document (e.g., a document having electronic or cryptology features have a lower probability of being forged) and/or any other information associated with the level of forgery.

In embodiments, Obtainability 708 may store a value associated a level of obtainability with one or more types of information (e.g., document or information in Document 702) received by electronic application 114 and/or verification server 120. For example, as shown in FIG. 7, document K8Y has a value of 5 for the level of obtainability. In embodiments, the value may be determined based on analyzing the one or more types of information described in the one or more steps in FIG. 6. In embodiments, different types of information may have different levels (and values) of obtainability. For example, a driver's license is most likely easier to obtain than a U.S. passport. In embodiments, the easier it is to obtain a document, the lower the value. In alternate embodiments, the easier it is to obtain a document, the higher the value. In embodiments, the ease of obtainability may be associated with the number of documents issued within a period of time, the number of persons that can obtain the document, the number of transactions associated with obtaining the document, and/or any other factor associated with the level of obtainability.

In embodiments, electronic application 114 and/or verification server 120 may combine the values in Reputation 704, Forgery 706, and/or Obtainability 708 to generate an electronic value. In embodiments, the values in Reputation 704, Forgery 706, and/or Obtainability 708 may be simultaneously generated and combined to generate an electronic value. In embodiments, the electronic value may be stored in database structure 700 or in another database structure. In embodiments, if the electronic value exceeds a particular threshold, then the combination of the values verifies a person's identity and/or whether the person is not a human trafficking victim. In embodiments, an electronic value that exceeds a particular threshold may results in a first type of electronic communication sent to web server 118 that indicates that a person's identify is verified and/or that the person is not a human trafficking victim. In embodiments, an electronic value that does not exceed a particular threshold may result in a second type of communication sent to web server 118 that indicates that a persons' identify is not verified and/or that the person is a human trafficking victim. In embodiments, the first type of communication may include different types of information and, as such, a different bit/byte size in the communication message than the second type of communication. In alternate embodiments, if the generated value is lower than a threshold, then this is a determination that the person's identity and status (e.g. not as a human trafficking victim) is verified. In alternate embodiments, if the generated value is higher than a threshold, then this is a determination that the person's identity and/or status is not verified. In embodiments, levels (e.g., values) of reputation, obtainability, and/or forgery may change based on additional electronic information and/or later changes to the types of information themselves.

FIG. 8A describes an example data structure 800 that stores one or more types of information that are used to verify a person's identity and/or to verify that a person is not a being forced to conduct services against their free will. In embodiments, the information describe in data structure 800 may be used at the initial verification or may be used to confirm continuous verification after the initial verification has occurred. In embodiments, data structure 800 may include a collection of fields such as Name 802, Financial 804, Address 806, and Identifier 808. Although FIG. 8A shows example fields 802-808, in other embodiments, data structure 800 may include fewer fields, different fields, additional fields, and/or differently arranged fields than depicted in FIG. 8A. In embodiments, verification server 120 may store some or all of data structure 800. Additionally, or alternatively, user device 112 and/or web server 118 may store some or all of data structure 800.

In embodiments, Name 802 may store a name information for one or more persons. In embodiments, the name information may be received in a manner described in step 506 in FIG. 5. In embodiments, Name 802 may include additional information such as gender, age, nationality, etc. In embodiments, Financial 804 may store financial information for one or more persons, such as described in Name 802. In embodiments, the financial information may be received in a manner described in step 602 in FIG. 6. In embodiments, Address 806 may store physical address information for one or more persons, such as described in Name 802. In embodiments, the physical address information may be received in a manner described in step 608 in FIG. 6. In embodiments, Identifier 808 may store identification information for one or more persons, such as described in Name 802. In embodiments, the identification information may be received in a manner described in step 606 in FIG. 6. As shown in FIG. 8A, for example, “Jane X” has a credit card, an address at 111 Main St, Chicago, and has a drivers license.

In embodiments, electronic application 116 and/or verification server 120 may use the information in fields 802, 804, 806, and/or 808 to determine the factors in fields 704, 706, and/or 708. In embodiments, data structure 800, via electronic application 116 and/or verification server 120, may receive updated information in any field in FIG. 8A after the initial verification. For example, data structure 800, via electronic application 116 and/or verification server 120, may receive the updated information based on sending an electronic communication or automatically receive updated information. In embodiments, electronic application 116 and/or verification server 120 may analyze information in fields 802, 804, 806, and/or 808 with information about the service described in the proposed electronic post. For example, if the person's age is determined to be 17 years old and the proposed electronic post has a service that is associated with someone over 18 years old, then electronic application 116 and/or verification server 120 may send an electronic communication to web server 118 that the proposed electronic post should not be electronically displayed.

FIG. 8B describes an example data structure 810 that stores one or more types of information that are used to verify a person's identity and/or to verify that a person is not a human trafficking victim. In embodiments, the information describe in data structure 810 may be used at the initial verification or may be used to confirm continuous verification after the initial verification has occurred. In embodiments, data structure 810 may include a collection of fields such as Name 812, Other Sites 814, and Reviews 816. Although FIG. 8B shows example fields 812-816, in other embodiments, data structure 810 may include fewer fields, different fields, additional fields, and/or differently arranged fields than depicted in FIG. 8B. In embodiments, verification server 120 may store some or all of data structure 810. Additionally, or alternatively, user device 112 and/or web server 118 may store some or all of data structure 810. Furthermore, in embodiments, data structure 810 may be part of data structure 800 or may be a separate data structure.

In embodiments, Name 812 may store a name information for one or more persons. In embodiments, the name information may be received in a manner described in step 506 in FIG. 5.

In embodiments, Other Sites 814 may store information about one or more websites and/or electronic applications associated with a person's name in Name 812. In embodiments, the information about the one or more websites and/or electronic applications may be received in a manner described in step 610 in FIG. 6. In embodiments, Reviews 816 may store information about one or more reviews associated with services provided by a person describe in Name 812. In embodiments, the review information may be received in a manner described in step 610 in FIG. 6. As shown in FIG. 8B, for example, “Rob P,” a person, has information associated with “APP INZ” and has one review from a third party.

In embodiments, data structure 810, via electronic application 116 and/or verification server 120, may receive updated information in field 608 and/or field 610 when a person, described in Name 812, adds posts, comments, and/or is given a review on another website and/or electronic application. In embodiments, electronic application 116 and/or verification server 120 may receive the updated information in field 814 and/or field 816 in real-time as a person, described in Name 812, adds posts, comments, and/or is given a review on another website and/or electronic application. In embodiments, data structure 810, via electronic application 114 and/or verification server 120, may receive updated information in field 608 and/or 610 simultaneously from multiple websites and/or electronic applications.

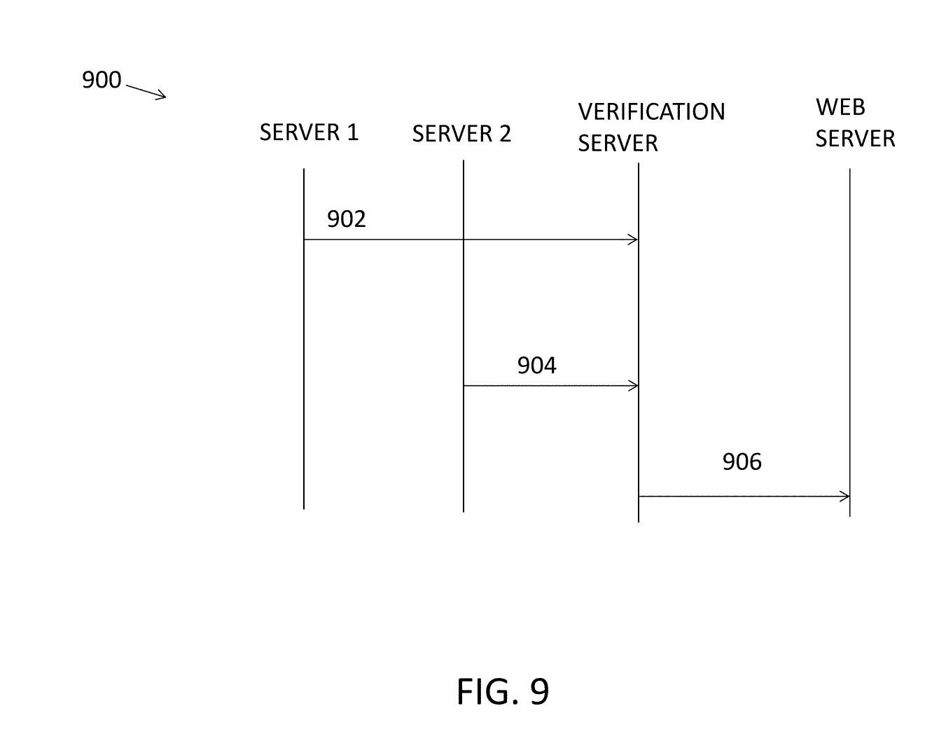

FIG. 9 describes an example communication flow process 900 for sending electronic information to provide additional and/or continuous verification server to verify information after the initial verification. As shown, FIG. 9 includes server 1 (e.g., social network server 122, and/or server 124), server 2 (e.g., social network server 122 and/or server 124), verification server (e.g., verification server 120), and web server (e.g., web server 118).

As shown in FIG. 9, server 1 may send an electronic communication 902 to the verification server. In embodiments, electronic communication 902 may include information about electronic posts, electronic posts from third parties about the verified person, photos of the verified person created by the person or created by third parties, videos of the verified person created by the person or created by third parties, and/or any other type of information. Also, as shown in FIG. 9, server 2 may send electronic communication 904 to the verification server. In embodiments, electronic communication 904 may include electronic posts, electronic posts from third parties about the verified person, photos of the verified person created by the person or created by third parties, videos of the verified person created by the person or created by third parties, and/or any other type of information. In embodiments, electronic communications 902 and 904 may be sent simultaneously. As shown in FIG. 9, the verification server may use the information in electronic communications 902 and 904 to determine whether to continue verification of a person whose been already been previously verified. As shown in FIG. 9, the verification server may send a verification message, or no verification message, within electronic communication 906 to the web server. Thus, the web server may then, based on electronic communication 906, determine whether to continue electronic display of an electronic post or to stop the electronic display of an electronic post. In embodiments, electronic communications 902 and 904 may occur simultaneously or one may occur before the other. In alternate embodiments, the verification server may have a portion or all of its verification processes performed by the web server; accordingly, electronic communication 906 may not occur. In embodiments, the electronic post may continue to be posted but only for particular services and the removal of electronic display of other services based on electronic communication 906.

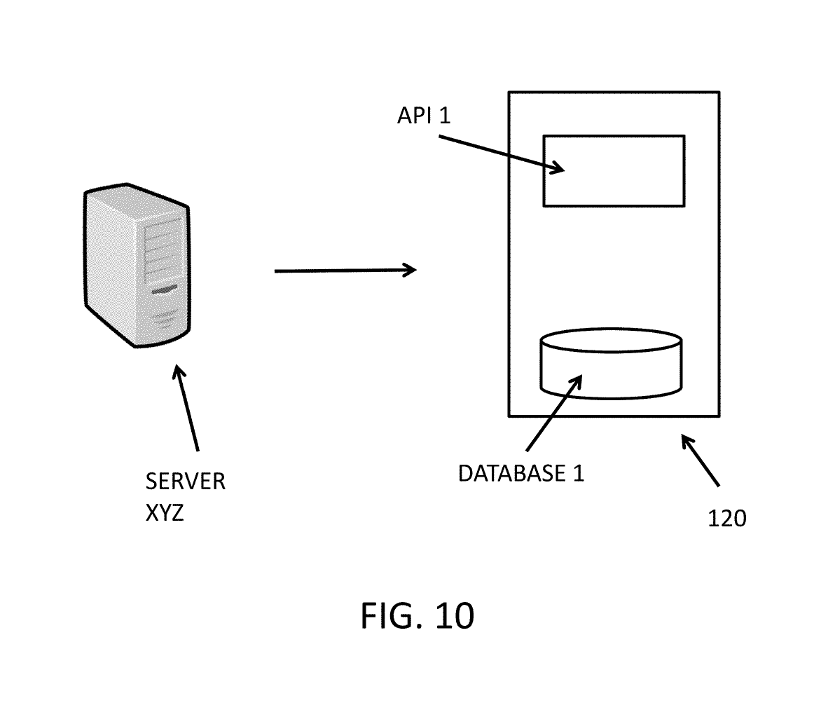

FIG. 10 shows an example diagram for analyzing information. As shown in FIG. 10, there is Server XYZ (e.g., social network server 122 or server 124), Database 1 (e.g., database structure 800 and/or 810), application programming interface (API) 1, and verification server 120. In embodiments, server XYZ may send electronic posts that include words, numbers, photos, videos, and/or any other textual, numerical, or multimedia-based information about a verified person from a website or electronic application (other than electronic application 114). In embodiments, the electronic information sent by server XYZ may be generated by the verified person or by a third-party about the verified person. In embodiments, API 1 may provide an electronic interface between server XYZ and verification server 120 to electronically communicate information for analysis by verification server 120. In embodiments, API 1 may also include electronic analysis processes that analyze electronic information received from server XYZ. In embodiments, the electronic information received by verification server 120 is compared to a database of words, phrases, numbers, and/or other information to determine whether the verified person can still be considered as not being found to conduct a service against their free will (e.g., not a human trafficking victim). In embodiments, the electronic information received by verification server 120 is compared to a database of words, phrases, numbers, and/or information to determine whether the verified person or another person is associated with any criminal activity. In embodiments, API 1 may also be used to analyze any post that may have words, number, photos videos, and/or any other textual, numerical, or multimedia-based information about other persons. Thus, the entity (or electronic entity) that controls server XYZ may determine the electronic content displayed on their website and also remove electronic content displayed on their website based on the electronic analysis performed by API 1.

In embodiments, server XYZ (using API 1 or other electronic resources) may determine words that indicate the verified person's status has changed and is now conducting services against their own free will. In embodiments, different words, phrases, and numbers, may be analyzed differently based on the type of electronic information. In embodiments, a phrase in one type of electronic post (e.g., on a social networking website) may be analyzed differently than if the phrase is included in another type of electronic post (e.g., on a professional/business web site).

In embodiments, verification server 120 may be provided electronic communications that include rules and requirements for analysis from server XYZ instead of using electronic rules stored by verification server 120.

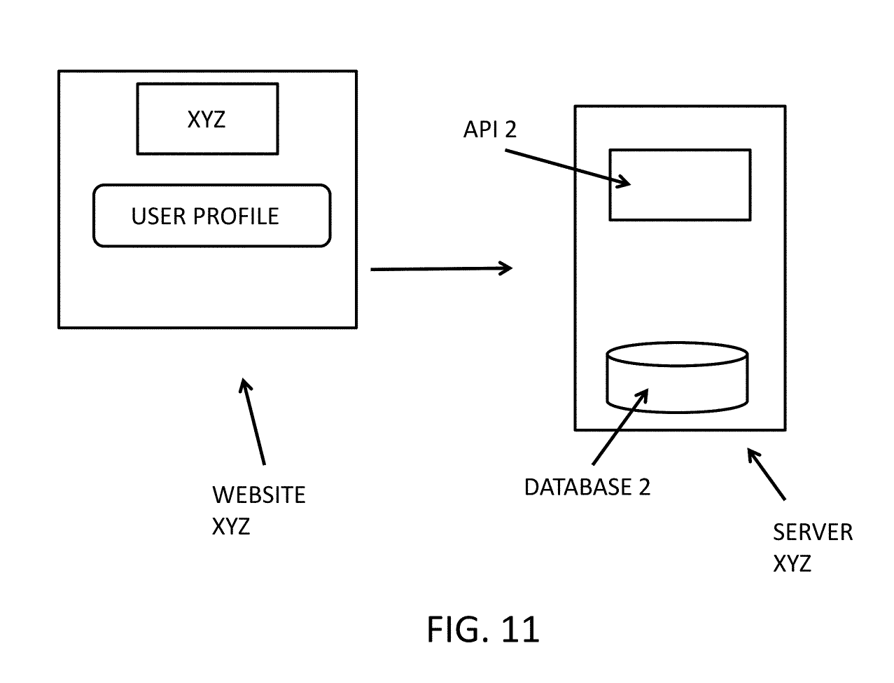

FIG. 11 shows an example diagram for analyzing information. As shown in FIG. 11, there is a website XYZ, server XYZ (e.g., social network server 122 or server 124), database 2 (e.g., database structure 800 and/or 810), and API 2. As shown in FIG. 11, server XYZ may include API 2 and database 2 to determine additional verification without having to send the electronic information to verification server 120. In embodiments, website XYZ may send electronic posts (via a user device such as user device 112) that include words, numbers, photos, videos, and/or any other textual, numerical, or multimedia-based information about a verified person from a website or electronic application (other than electronic application 114). In embodiments, the electronic information sent by website XYZ may be generated by the verified person or by a third-party about the verified person. In embodiments, API 2 may provide an electronic interface between the user device and server XYZ to electronically communicate information for analysis by server XYZ. In embodiments, API 2 may also include analysis tools that analyze electronic information received from server XYZ. In embodiments, the electronic information received by server XYZ is compared to a database of words, phrases, numbers, and/or other information to determine whether the verified person can still be considered as not being a human trafficking victim. In embodiments, the electronic information received by server XYZ is compared to a database of words, phrases, numbers, and/or information to determine whether the verified person or another person is associated with any criminal activity. In embodiments, API 2 may also be used to analyze any post that may have words, number, photos videos, and/or any other textual, numerical, or multimedia-based information about other persons. Thus, the entity (or electronic entity) that controls server XYZ may determine the electronic content displayed on their website and also remove electronic content displayed on their website based on the electronic analysis performed by API 2.

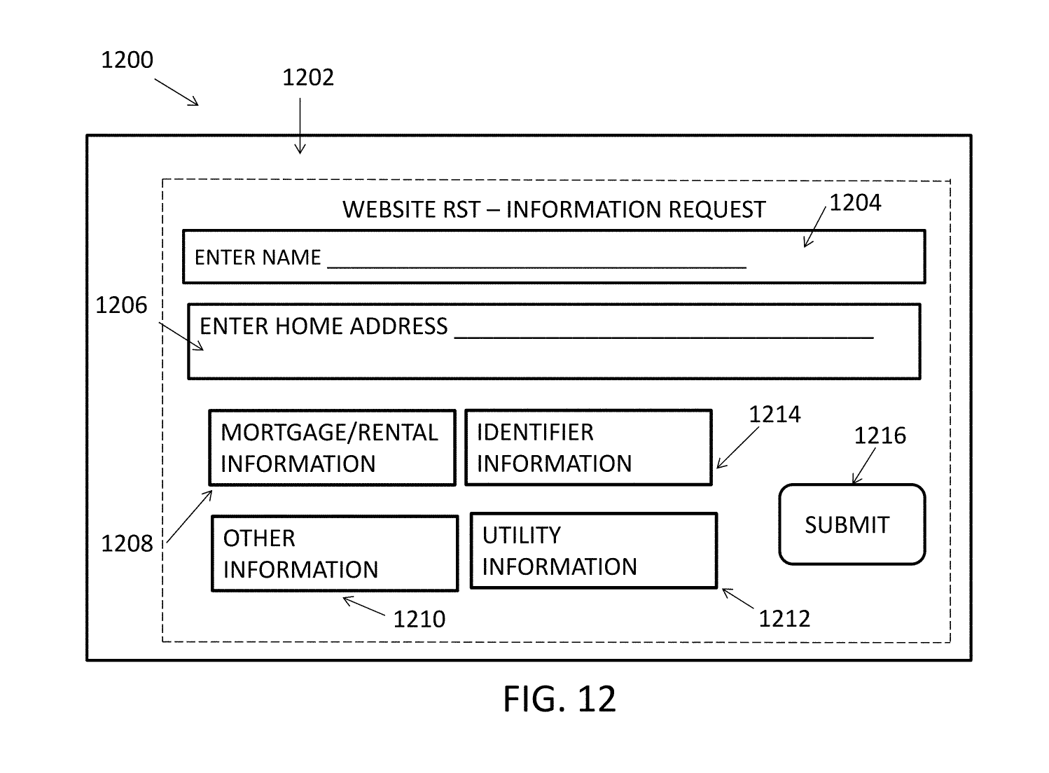

FIG. 12 describes an example screenshot 1200. In embodiments, example screenshot 1200 shows electronic information associated with an electronic form as displayed on user device screen 1202 (e.g., part of a user device, such as user device 112). In embodiments, example screenshot 1200 shows an electronic form associated with website RST (e.g., electronic application 116). In embodiments, the website RST may be associated with a verification server, such as verification server 120 (as described in other figures). In embodiments, example screenshot 1200 may be displayed upon a user (of user device 112) entering a password (as generated and described in FIGS. 1A-1E and FIG. 5) into website RST.

In embodiments, example screenshot 1200 includes one or more electronic data entry fields 1204, 1206, 1208, 1210, 1212, and 1214. In embodiments, a person who wishes to post video, photos, animation, user-generated content, non-user generated content, and/or any other content on an electronic board, website, electronic magazine, paper-based magazine or newspaper, and/or any other type of publication, may be required to have their identity and /or their status as not being a human trafficking victim to be verified prior to publication (e.g., electronically, electro-mechanically, mechanically, etc.) of the advertisement and/or post. While the electronic data entry form is shown in a particular format, the electronic data entry form may have different fields, icons, selection buttons, etc., to input other types of information and perform the same or similar actions as described in FIG. 12.

In embodiments, a person may enter their name information into field 1204, home address information into field 1206, mortgage or rental information into field 1208, other types of information into field 1210, and utility information into field 1212. In embodiments, entering information into any of the fields shown in screenshot 1200 may result in requests for additional information on additional screenshots associated with website RST. In embodiments, once all the information is entered into the fields, submit button 1216 may be selected. Upon selection, the information entered into the fields (in screenshot 1200) may be sent, via the user device, to a verification server (e.g., verification server 120) associated with website RST. In embodiments, the verification server may analyze the information as described in any or all of the above figures. Alternatively, the information entered into the fields (in screenshot 1200) may be analyzed by the user device as described in any or all of the above figures.

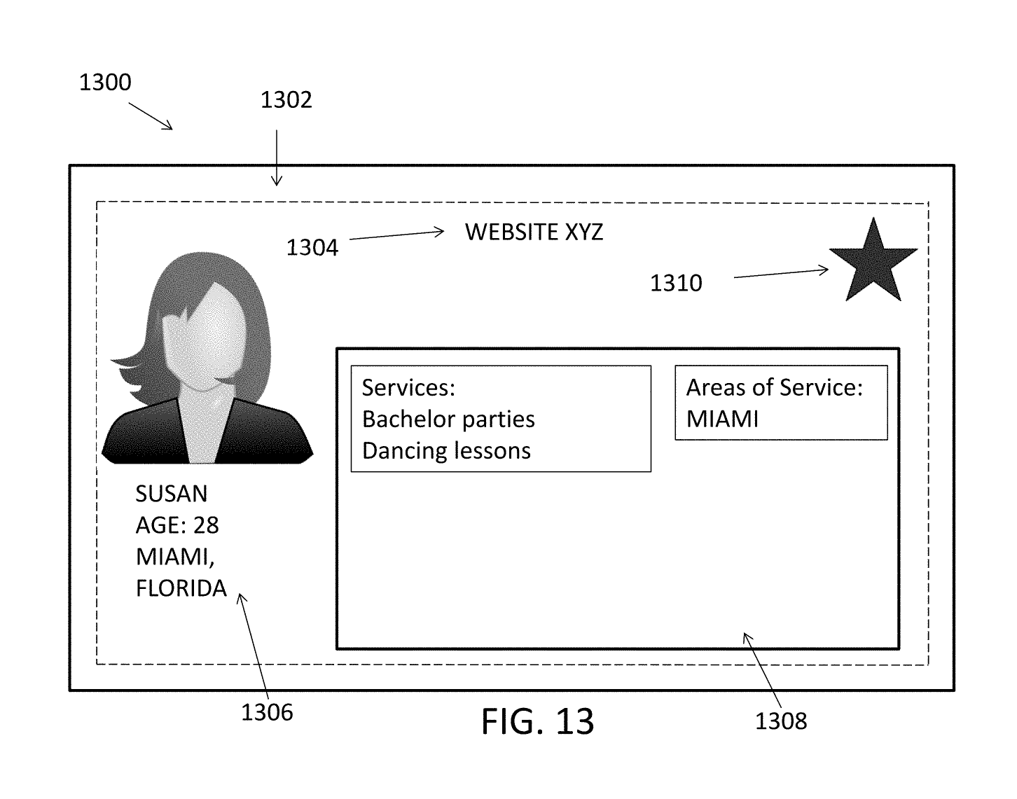

FIG. 13 shows an example screenshot 1300. In embodiments, screenshot 1300 shows an example electronic post (e.g., an advertisement) 1302 as shown on a website (electronically displayed on a user device, such as user device 112) associated with a web server, such as web server 118. In embodiments, electronic post 1302 may be displayed upon the web server receiving an electronic communication from a verification server (e.g., verification server 120) that the person providing a service, as described in the electronic post, has had their identity verified and/or their status being verified as not being a human trafficking victim. While the electronic post is shown in a particular format, the electronic post may have different fields, icons, information, images, etc., to perform the same or similar actions as described in FIG. 13.

In embodiments, electronic post 1302 may include identification of the website (website 1304); identity information 1306, which includes a picture (an actual image or a computer generated place-holder image) of the person, providing the service described in electronic post 1302, name, age, and location information. In embodiments, service information 1308 includes information about the types of services provided by the person described in identity information 1306. In embodiments, a symbol 1310 may be displayed on electronic post 1302 that indicates that the person, described in identity information 1306, has had their identity verified and their status as not being a human trafficking victim as also being verified. In alternate embodiments, symbol 1310 may not be displayed even though the status of the person has been verified.

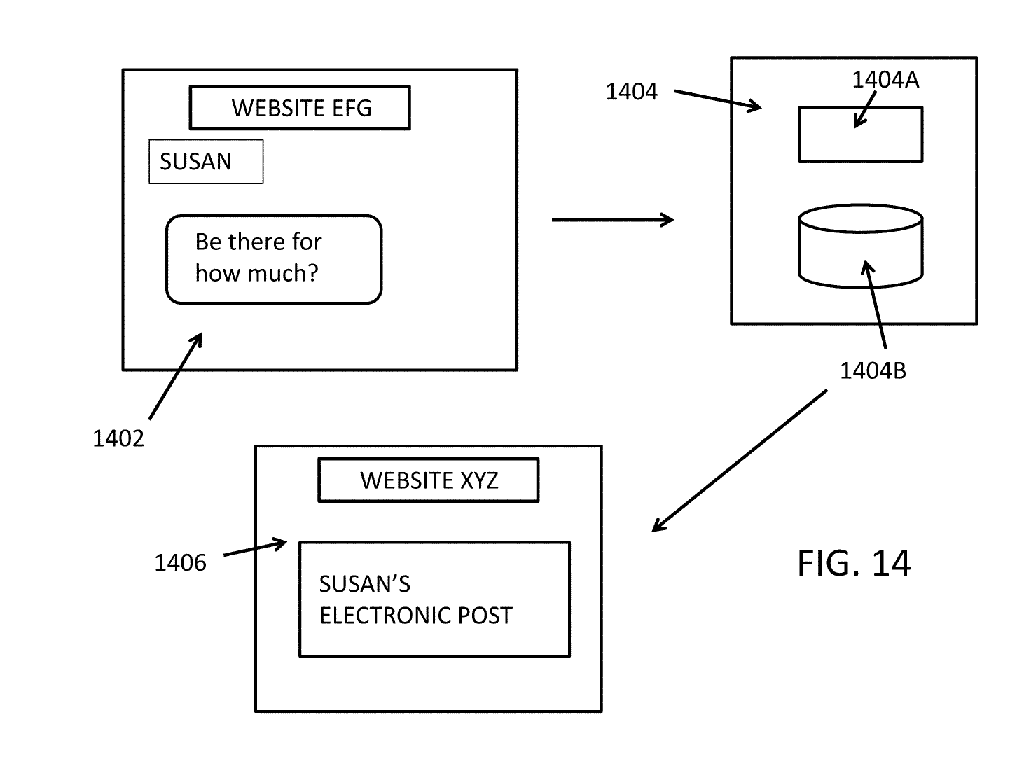

Once a person is verified, there may be additional verification that may occur after the initial verification. In embodiments, FIG. 14 shows an example diagram of additional verification. As shown in FIG. 14, Susan (who was described in FIG. 13) may have a social networking electronic account on website EFG. On website EFG, Susan initiates an electronic message stating “Be there for how much?” as shown in screenshot 1402. In embodiments, the information associated with the electronic message is sent to a server 1404 (e.g., such as verification server 120 or web server 118) and analyzed via an API 1404A using information stored in data structure 1404B in a manner similar to that described in FIG. 11 or 12. In embodiments, server 1404 may determine that Susan should continue to be verified and sends an electronic message that continues to allow Susan's electronic post to be displayed on website XYZ as shown in screenshot 1406.

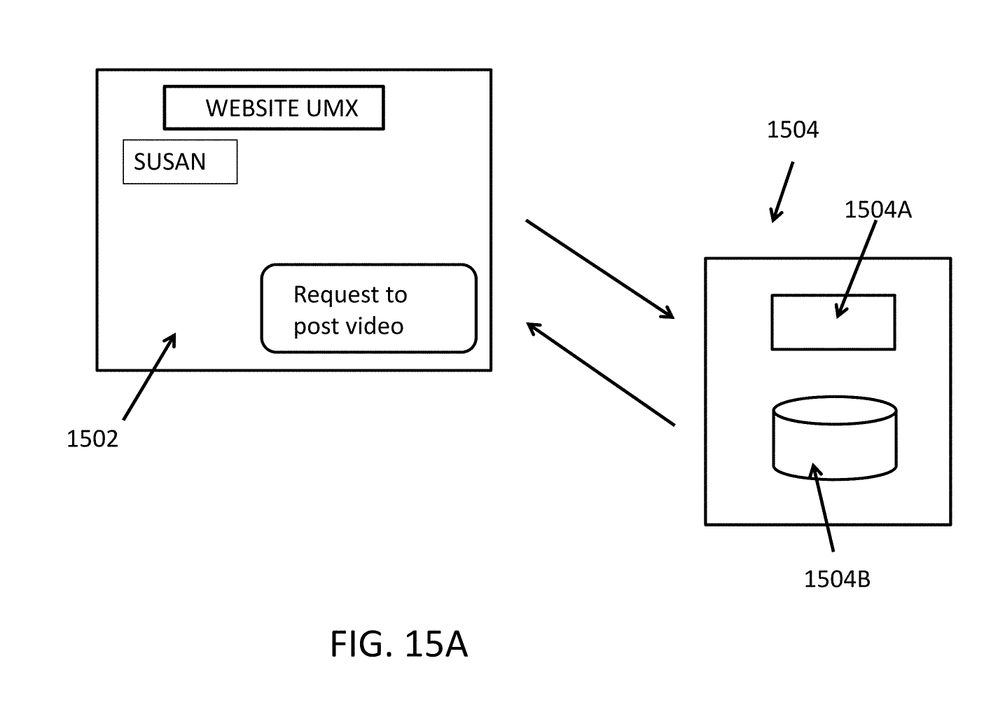

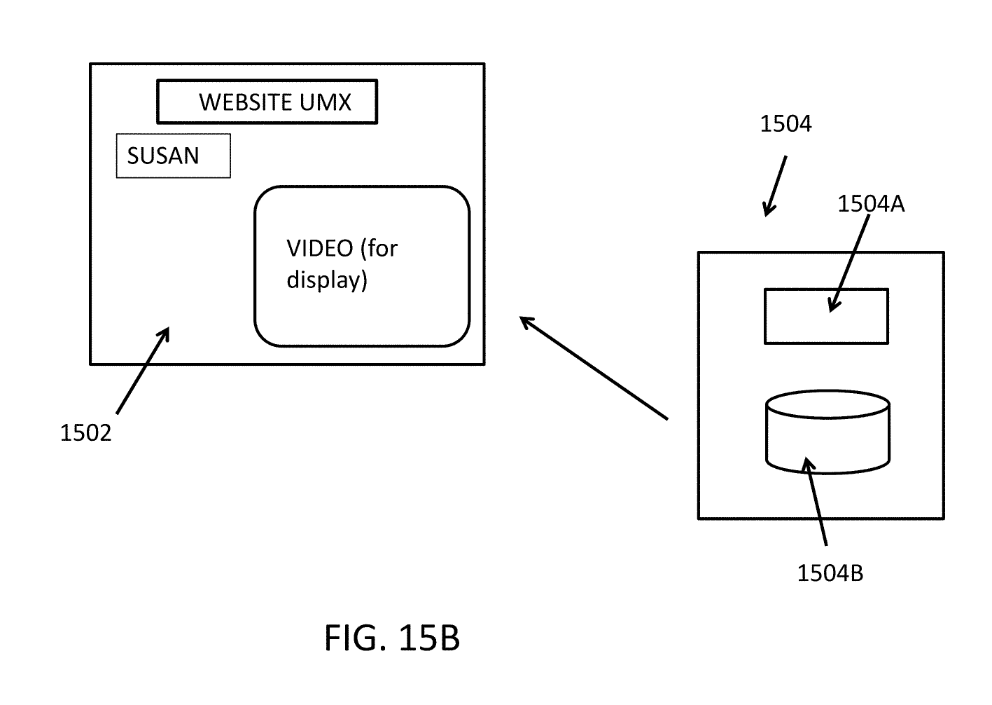

FIG. 15A shows example diagram of verifying information in video-based content from a third-party electronic application. As shown in FIG. 15A, Susan wants to post a video of herself on website UMX. Upon uploading the electronic information associated with the video onto website UMX, website UMX may use an electronic application, associated with verification server 120, to generate an electronic identifier (e.g., a fingerprint).

In embodiments, the electronic identifier may be generated at the same time that information is being uploaded onto website UMX. In embodiments, the electronic identifier may be generated by electronically extracting information associated with a user's face, voice, and/or other features. In embodiments, the electronically extracted information may be electronically compressed and an electronic identifier is then generated for association with the electronically compression information.

In embodiments, the electronically extracted information may be combined with other information associated with the third-party website. In embodiments, the information associated with the third-party website may include information about the third-party website's geographic registration, information about the type of content provided by the third-party website, and/or other information about the third-party website.

The generated electronic identifier is then stored by website UMX. As shown in FIG. 15A, website UMX may electronically send the electronic identifier and/or the video content to server 1504 via API 1504A which is electronically associated with website UMX. In embodiments, server 1504 may analyze the electronic information in the electronic identifier and/or the video content to determine whether Susan is a previously verified person. In embodiments, the analysis may include electronically decompressing the information in the electronic identifier to analyze the identity of the person in the video. In embodiments, the analysis may include partially decompressing the information and maintaining compression of other types of information.

In this non-limiting example, server 1504 may use database 1504B to find information about Susan and compare Susan's stored information with the information received from website UMX via API 1504A. In embodiments, the verification may be based on image content within the electronic identifier, on texts or passwords that are embedded in the electronic identifier. For example, Susan may verbally state a password within the video which is then analyzed and confirmed by server 1504. Additionally, or alternatively, server 1504 may analyze Susan's facial imagery and compare it to stored facial imagery.

Upon verifying Susan's identity, server 1504 sends an electronic communication to website UMX that Susan is a verified person and that the video can be electronically posted on website UMX, as shown in FIG. 15B. In embodiments, the electronic identifier and multimedia content are stored by server 1504. In embodiments, server 1504 may further generate a second electronic identifier based on the electronic identifier, the multimedia content, and/or the stored verified information. In embodiments, the second electronic identifier may have portions that are compressed (associated with the electronic identifier) and other portions that are not compressed.

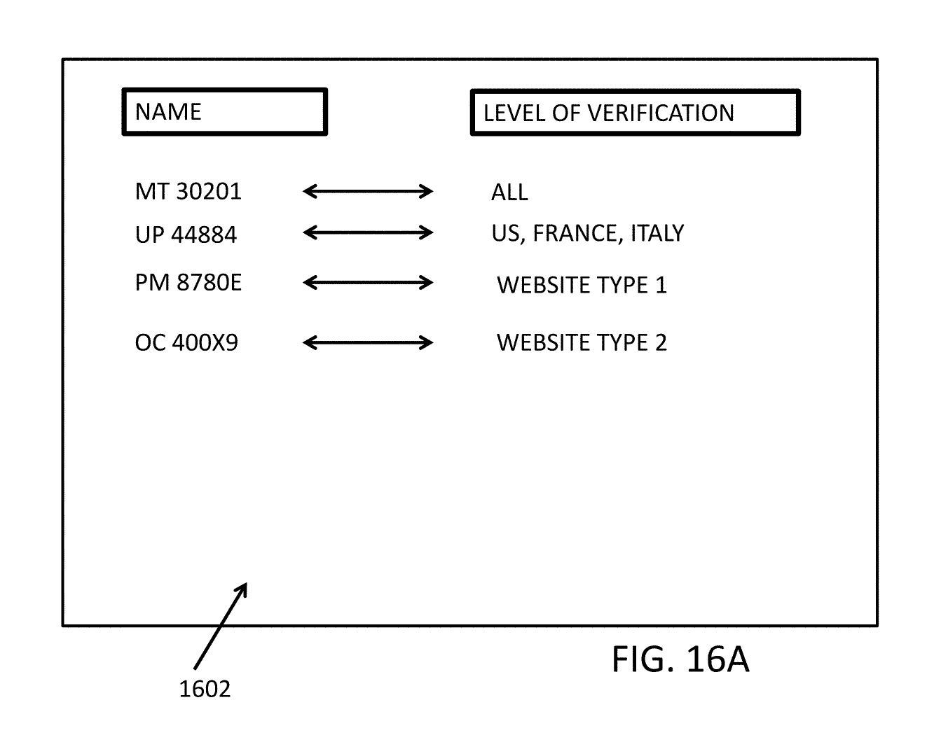

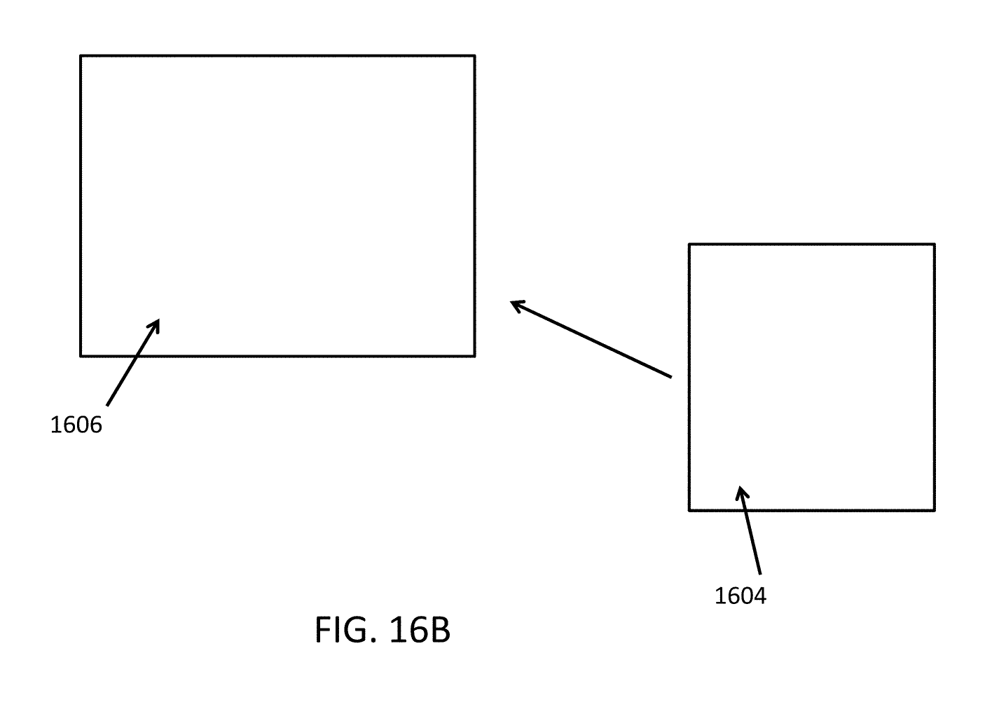

FIG. 16A describes an example electronic list 1602 of verified users generated by verification server 120. In embodiments, verification server 120, previously, may have received verification requests from one or more users who in the past requested verification, which were verified by verification server 120, and stored as verified users by verification server 120. In embodiments, verification server 120 may generate one or more different types of electronic lists (including electronic list 1602) based on past requests by third-party websites.

For example, third-party websites located in a particular country (e.g., Japan) may receive an electronic list that is different than third-party websites located in another country (e.g., India). Also, for example, past requests from third-party websites associated with a particular type of content may result in a particular type of electronic list.

In embodiments, there may be an electronic list generated that is based on past requests from third-party websites that publish videos, or that publish photos, or that publish adult-orientated content, and/or any other format or content. In embodiments, electronic list may also include a mixture of users with different levels of verification. By including a mixture of different verified user, verification server 120 may send the list to a third-party website which may then further analyze and determine which verified users can publish information on their website.

As shown in FIG. 16A, electronic list 1602 has verified users that have different levels of verification. For example, as shown in FIG. 16A, user “MT30201” has been verified as “All” which means that user “MT30201” is verified for any type of third-party website. Also, as shown in FIG. 16A, user “UP44884” has been verified for particular geographic locations. As shown in FIG. 16A, user “OC 400X9” has been verified for a particular type of website, “web site 2.”

As shown in FIG. 16B, server 1604 (e.g., verification server 120) may send an electronic list, such as electronic list 1602, to server 1606 (a server associated with a third-party website). In embodiments, electronic list 1602 may be sent based on a request by server 1606 or electronic list 1602 may be sent automatically by server 1604 based on past verification requests by server 1606.

Thus, in the one or more figures described above, systems, devices, and/or methods described herein allows for (1) one or more persons to provide one or more documents that may be used to determine that a person is not a human trafficking victim, (2) analyze the one or more documents to determine that the person's age, location, and/or other information is valid and that the person is not a human trafficking victim, (3) using one or more APIs to cross check information, (4) electronically integrate with other computing systems, (5) electronically analyze messages, electronic posts, photos, and/or other information, in real-time, that are associated with other electronic applications and/or websites, (6) electronically analyze biometric information to verify a person's identity, and (7) conduct criminal background checks and employment/immigration status verifications.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing and/or electronic networking environment and may require one or more computing devices, as described in FIG. 2, to complete such actions. Furthermore, it will be understood that these various actions can be performed by using a touch screen on a computing device (e.g., touching an icon, swiping a bar or icon), using a keyboard, a mouse, or any other process for electronically selecting an option displayed on a display screen to electronically communicate with other computing devices as described in FIG. 2. Also it will be understood that any of the various actions can result in any type of electronic information to be displayed in real-time and/or simultaneously on multiple user devices (e.g., similar to user device 124). For FIGS. 5 and 6, the order of the blocks may be modified in other implementations. Further, non-dependent blocks may be performed in parallel. Also, it will be understood that any electronic post may include information about services and other information that may include user-generated and non-user generated text, numbers, photos, animation, multimedia content, and/or any other type of electronic content that can be analyzed for any of the reasons described in the above figures. It will be understood that an electronic post may be an advertisement, an electronic message, a text message, a SMS message, a MMS message, and/or any other electronic generated content (user and non-user) that can be electronically displayed on a user device screen.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. An electronic communications method, comprising:
receiving, by a device, one or more electronic communications;
analyzing, by the device, the one or more electronic communications;
verifying, by the device, an identity of one or more individuals associated with an electronic post,
the electronic post including one or more services being offered by the one or more individuals;
generating, by the device, an electronic list of the one or more individuals that have been verified by the device.

2. The electronic communications method of claim 1, where the electronic list Is associated with a particular type of electronic content.

3. The electronic communications method of claim 1, where the electronic list is associated with a particular geographic location.

4. The electronic communications method of claim 1, where the electronic list includes information about users with different verification levels.

5. The electronic communications method of claim 1, further comprising:
sending the electronic list to a particular server based on the particular server previously requesting information.

6. The electronic communications method of claim 6, where the electronic list includes verified users that are associated with particular content generated by the particular server.

7. The electronic communications method of claim 6, where the electronic list includes verified users that are associated with a particular geographic location associated with particular content generated by the particular server.

8. The electronic communications method of claim 5, where the electronic list is automatically sent to the particular server.

9. A device, comprising:
memory; and
a processor to:
receive one or more electronic communications,
the one or more electronic communications including one or more electronic identifiers;
analyze the one or more electronic identifiers;
verify, using an electronic list, an identity of one or more individuals associated with at least one of the one or more electronic identifiers;
send a verification message; and
store the one or more electronic identifiers with other identification information.

10. The device of claim 9, where the least one of the one or more the electronic identifiers includes compressed electronic information.

11. The device of claim 10, where the compressed electronic information includes multimedia information.

12. The device of claim 9, further comprising:
generate a second electronic identifier based on the at least one electronic identifier of the one or more electronic identifiers.

13. The device of claim 9, where the electronic list is updated based on the analysis of the one or more electronic identifiers.

14. A method, comprising:
receiving an electronic identifier,
the electronic identifier includes compressed electronic information;
analyzing, by an electronic device, the electronic identifier;
verifying, by the electronic device, the identity of an individual associated with the electronic identifier,
the verifying includes electronically analyzing the compressed information with stored electronic information; and
sending one or more communications that include permission to post services associated with the individual.

15. The method of claim 14, where analyzing the information includes analyzing
at least one or more of:
facial imagery of the individual;
audio associated with the individual; and
text associated with the individual.
